(19) United States
(12) Patent Application Publication
(10) Pub. No.: US 2012/0329445 A1
(43) Pub. Date: Dec. 27, 2012

(54) Methods and Apparatus for Bluetooth Functionality Verification

(75) Inventor: Doron M. Elliott, Detroit, MI (US)

(73) Assignee: FORD GLOBAL TECHNOLOGIES, LLC, Dearborn, MI (US)

(21) Appl. No.: 13/167,869

(22) Filed: Jun. 24, 2011

(51) Int. Cl. H04W 4/04; H04W 8/20

(52) U.S. Cl. 455/420; 455/41.3

(57) ABSTRACT

A testing method includes pairing a BLUETOOTH device and a vehicle computing system (VCS) and setting the device to a preferred device. The method also includes streaming audio from the device to the VCS, such that the audio is played by the VCS. The method includes suspending the VCS and verifying that the VCS and the device are disconnected, then resuming the suspended VCS. The method further includes instructing the audio to play from the VCS, if the audio does not resume play. The method additionally includes instructing the audio to move to a next track, using the VCS in conjunction with an audio video remote control profile (AVRCP). Also, the method includes validating the operability between the device and the VCS contingent at least on the discontinuation of audio playback when the VCS is suspended and the establishment of an audio connection resulting in audio playback upon resumption of the suspended VCS.

### TECHNICAL FIELD

The illustrative embodiments generally related to a method and apparatus for BLUETOOTH functionality verification.

### BACKGROUND

When providing a user with a system capable of wireless communication with various wireless devices, it may be desirable to provide access to a variety of wireless formats. A common wireless format is BLUETOOTH, and many wireless devices that are capable of inter-device communication are equipped with BLUETOOTH functionality.

These devices, however, are not always functional in the same fashion. Due to differences in various BLUETOOTH protocols installed on a device, and the particular manner in which a certain device communicates information using the protocol, certain incompatibilities may arise between an OEM provided system and wireless devices that are used in conjunction with that system.

When a user buys an OEM provided system, for example, a vehicle equipped with a vehicle computing system having BLUETOOTH capability, the user generally expects that their wireless BLUETOOTH device is compatible with the system. The OEM may even release a list of approved devices. Because of device nuances, however, it may be desirable to verify the operability of a particular device before listing the device as an approved device.

Similarly, certain device developers may develop devices or functionality specifically designed to interact with the vehicle computing system. Before informing customers of the usefulness of such devices, the OEM and/or the device manufacturer/developer may wish to verify that the device, in fact, can communicate with the system and work as intended.

Since a user may blame the OEM, even if the problem lies with the device and not the vehicle computing system, some measure of testing to ensure device functionality and communication capability may help ensure that a customer is not disappointed.

### SUMMARY

In a first illustrative embodiment, an exemplary testing method includes pairing a BLUETOOTH device and a vehicle computing system (VCS) and setting the device to a preferred device. The illustrative method also includes streaming audio from the device to the VCS, such that the audio is played by the VCS.

Also, this illustrative method includes suspending the VCS and verifying that the VCS and the device are disconnected, then resuming the suspended VCS. The method further includes instructing the audio to play from the VCS, if the audio does not resume play. The method additionally includes instructing the audio to move to a next track, using the VCS in conjunction with an audio video remote control profile (AVRCP). Also, the method includes validating the operability between the device and the VCS contingent at least on the discontinuation of audio playback when the VCS is suspended and the establishment of an audio connection resulting in audio playback upon resumption of the suspended VCS.

In a second illustrative embodiment, an exemplary method includes searching for a paired wireless device via a vehicle computing system (VCS), wherein the wireless device has at least a minimum number of contacts stored thereon and downloading the contacts via the VCS.

The illustrative method also includes verifying that the contacts have been downloaded by accessing one or more contacts via the VCS and then disconnecting the VCS from the device.

Once the device has been disconnected, the process includes deleting one or more contacts from the device while the device is disconnected from the VCS and adding one or more contacts to the device while the device is disconnected from the VCS. The device is then reconnected to the VCS.

After the device has been reconnected, the process includes verifying that the at least one of the deleted contacts is no longer available via the VCS and verifying that at least one of the added contacts is available via the VCS. The process also includes validating the operability between the device and the VCS contingent on at least verifying that the contacts are downloaded to the VCS and are accessible via the VCS, that the deleted contacts are no longer available via the VCS and that the added contacts are available via the VCS.

In a third illustrative embodiment, a method includes connecting a vehicle computing system (VCS) and a device, wherein the device includes an address book with at least one contact. The method also includes downloading the address book to the VCS and calling the device, from a phone number stored in the address book of the device.

The process further includes verifying that contact information associated with the phone number from which the calling was performed is displayed by the VCS. Also, the process includes validating the operability between the device and the VCS contingent at least on verifying that contact information associated with the phone number from which the calling was performed is displayed on the VCS.

In a fourth illustrative embodiment, a method includes connecting a vehicle computing system (VCS) and a device, wherein the device has at least one ringtone associated therewith, which plays when an incoming call arrives. The method also includes calling the device and verifying that the VCS plays the ringtone associated with the device when the device is called.

The method additionally includes validating the operability between the device and the VCS contingent at least on verifying that the VCS plays the ringtone associated with the device when the device is called.

In a fifth illustrative embodiment, a method includes connecting a vehicle computing system (VCS) and a device and calling the device. The method also includes rejecting an incoming call to the device and verifying that the VCS ceases display of the incoming call once the call has been rejected.

The method further includes validating the operability between the device and the VCS contingent at least on verifying that the VCS ceases display of the incoming call once the call has been rejected.

In a sixth illustrative embodiment, a method includes connecting a vehicle computing system (VCS) and a device and calling the device. The method further includes answering an incoming call to the device and verifying that the VCS establishes a hands-free state for handling the incoming call,

The method additionally includes validating the operability between the device and the VCS contingent at least on verifying that the VCS establishes a hands-free state for handling the incoming call.

In yet another illustrative embodiment, a method includes connecting a vehicle computing system (VCS) and a device and placing a call through the device. The method further includes verifying that the VCS establishes a hands-free state for handling the placed call, including displaying known contact information for a call recipient if available. Also, the method includes validating the operability between the device and the VCS contingent at least on verifying that the VCS establishes a hands-free state for handling the placed call, including displaying known contact information for a call recipient if available.

### BRIEF DESCRIPTION OF THE DRAWINGS

FIG. 1 shows an illustrative example of a vehicle computing system;

FIG. 2 shows an illustrative example of a general test process;

FIG. 3A shows an illustrative example of a process for testing audio playback capability;

FIG. 3B shows a second example of testing audio playback capability with a meta-data component;

FIG. 3C shows an example of testing audio playback control from a VCS;

FIG. 3D shows an example of testing control over an incoming text message while audio playback is processing;

FIG. 3E shows an example of testing control over an incoming call while audio playback is processing;

FIG. 4 shows an example of a process for testing contact import from a device to the VCS;

FIG. 5 shows an example of testing a caller ID feature of the VCS; and

FIG. 6 shows an example of testing a ringtone feature of the VCS.

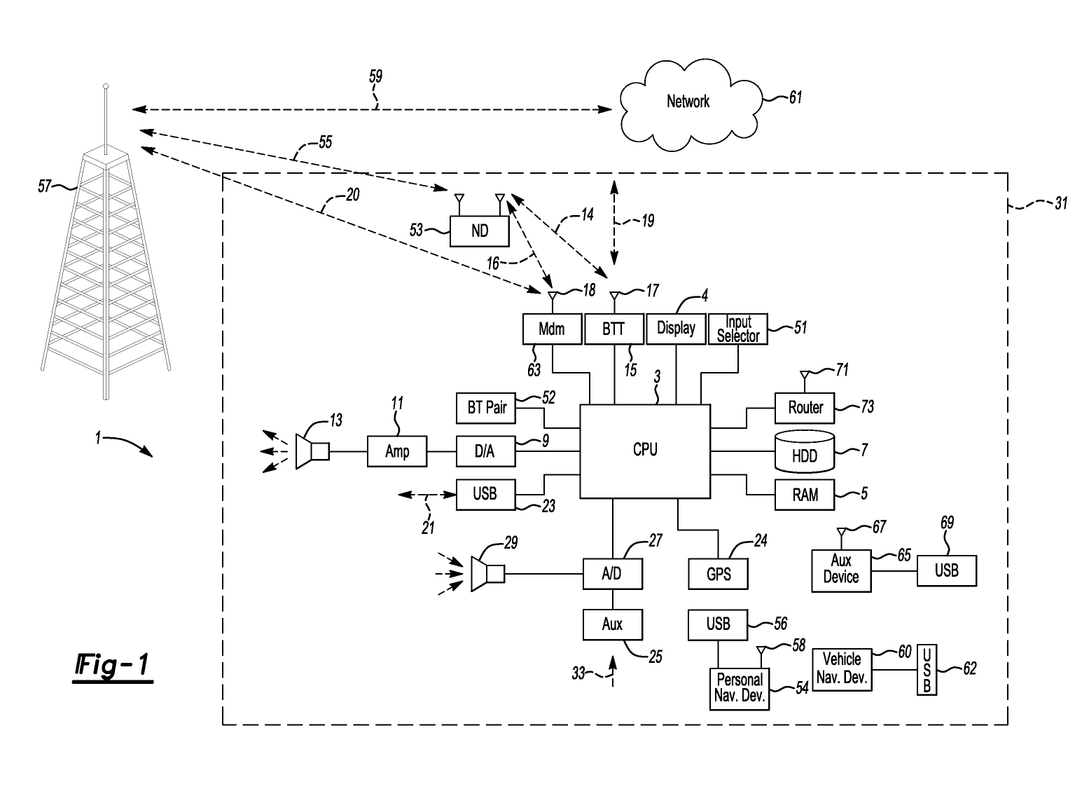

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The illustrative BLUETOOTH interoperability test procedures described herein help detail “step by step” guides to testing BLUETOOTH devices that may support one or more of the following profiles: A2DP, AVRCP (1.0, 1.3, or 1.4), HFP, MAP, PAN, PBAP, and VCSML. All procedures discuss are exemplary in nature, and serve to show examples of processes that may be used to verify the workability and compatibility of a BLUETOOTH device with a vehicle computing system or other system.

It is recognized that known replacement steps may be substituted for some of the exemplary steps without loss of the nature of the inventive processes detailed herein. Further, while the steps are enumerative, they are not exhaustive, nor are all the steps required for every process. What is described are certain functional illustrative implementations that are representative of types of tests performable to help ensure device functionality.

The test procedures may include a purpose, pre-test conditions, procedures, and expected results for each test. In the event that the expected result is not met for an executed test, a Frontline Bluetooth, Trace Devlog, and detailed notes may be used to further explore that test.

Certain abbreviations are presented in conjunction with the exemplary tests. What follows is a list of the common abbreviations:

| | |
|---|---|
| A2DP | Advanced Audio Distribution Profile |
| AVRCP | Audio Video Remote Control Profile |
| Devlog | Internal VCS logging tool. |
| DUT | Device Under Test |
| Expected Result | The items within the expected result desired to be |
| | met to achieve a ‘Pass’ for the test. |
| HFP | Handsfree Phone Profile |
| MAP | Message Access Profile |
| PAN | Personal Area Networking Profile |
| Pass Criteria | The percentage desired to determine if the DUT |
| | achieves a “Pass’ for the test. |
| PBAP | Phonebook Access Profile |
| Pre-Test Condition | The state of the system and the DUT prior to the |
| | beginning of the procedure. |
| Procedure | The exemplary steps within the test. |
| Purpose | The general objective of the test case |
| Resume | The method of turning a Vehicle Computing |
| | System (VCS) ‘ON’ |
| Device Profiles | Definition of the capabilities of the DUT. |
| Suspend | The method of turning the VCS ‘OFF’ |

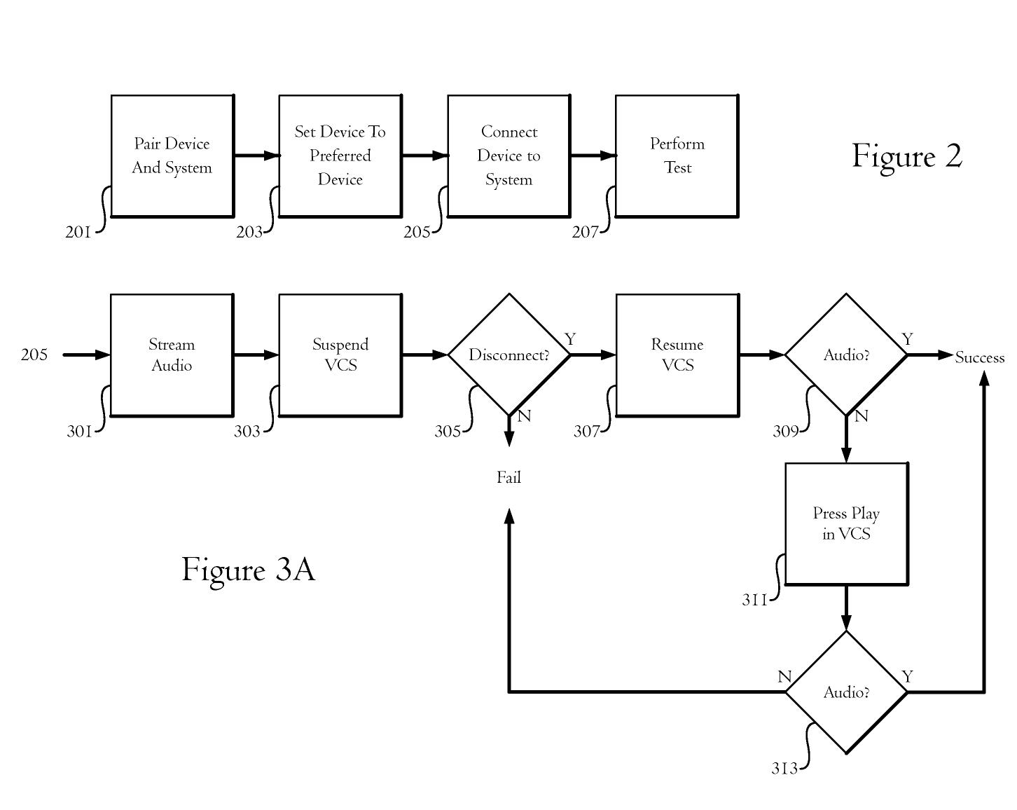

FIG. 2 shows an exemplary embodiment of a general process for testing a device. In a first step, the device is paired with a system with which the device is intended to interact 201. Pairing, in general, allows the system to recognize and communicate with the paired device.

Next, the device may be set to a preferred device within the system 203. This may cause the system to select the device as a primary device, if more than one available device is present. This may also cause the system to automatically connect to the device without searching for other devices, once the device has been discovered, since the device is set as the primary device.

The device is then connected to the system 205. This may be automatically accomplished by simply turning on the device and the system, or it may require some active initiation by a user.

Finally, in this general process, one or more tests are performed on the device to determine the workability and compatibility of the device in conjunction with the computing system to which it is connected 207.

What follows is a list of numerous exemplary test procedures. After this list, certain of the procedures are described in greater detail for purposes of illustrating the steps involved therewith.

A first series of exemplary tests may be directed at the concept of connection management. Connection management includes, but is not limited to, pairing and connection of a device to a VCS or other computing system. In the event that the combination of profiles supported by the device under test is not listed, the test case that best matches the capabilities of the device under test may be used.

Pairing and Connection:
Device Profiles HFP or A2DP
To Be Determined Validate pairing and connection between the device under test and (TBD) VCS
Pre-Test Condition 1. Delete all previous devices paired within the VCS.
Procedure 1. Place VCS into discoverable mode.
   2. Search for VCS from the DUT.
   3. Select VCS on the DUT and input the PIN.
   4. When prompted to download the phonebook, select yes.
   5. When prompted to confirm phone number, select OK.
   6. Repeat steps above sufficient number of additional times. In one exemplary embodiment the test is repeated nine times, but repetition of the test can be done more or fewer times as is required by the situation.
Expected Result 1. The device under test shall pair and remain connected.

Automatic Connection—Handsfree (No Call Active)
Device Profiles DUT supports: HFP only
TBD Validate VCS initiated connection between the device under test.
Pre-Test Condition 1. DUT and VCS have been paired.
   2. DUT is set to ‘Favorite’ device.
   3. Auto-Phonebook Download is set to ON.
   4. VCS is set to suspend (i.e. off)
   5. DUT is on.
   6. Bluetooth on DUT is set to ON.
   7. Repeat steps above sufficient additional times
Procedure 1. Switch VCS from suspended state to resume state (i.e. on)
Expected Result 1. VCS shall establish a connection to the DUT and remain connected.

Handsfree Phone and A2DP/AVRCP 1.0 Connection
Device Profiles DUT supports HFP and A2DP and AVRCP 1.0
TBD Validate that VCS is able to establish an HFP, A2DP, and AVRCP connection with the DUT.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. Repeat sufficient additional times.
Procedure 1. Suspend VCS.
   2. Verify that VCS disconnects from the device.
   3. Resume VCS.
   4. If music does not resume playing, press play within VCS menu.
   5. Press Next Track to confirm AVRCP connection.
Expected Result 1. Media does not continue to play upon disconnect.
   2. Upon resume, VCS establishes connection with DUT for HFP, A2DP, and AVRCP.
   3. Connection is maintained.

Handsfree Phone A2DP/AVRCP 1.3 Connection
Device Profiles DUT supports HFP and A2DP and AVRCP 1.3
Purpose Validate that VCS is able to establish an HFP, A2DP, and AVRCP connection with the DUT.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. DUT has at least N media tracks stored. In one illustrative embodiment,
N=5, but it can be set to an appropriate number for a given test.
   6. Repeat sufficient additional times.
Procedure 1. Suspend VCS.
   2. Verify that VCS disconnects from the device.
   3. Resume VCS.
   4. If music does not resume playing, press play within VCS menu.
   5. Verify that meta-data of current playing track is displayed via VCS.
   6. Press Next Track via VCS.
Expected Result 1. Media does not continue to play upon disconnect.
   2. Upon resume, VCS establishes connection with DUT for HFP, A2DP, and AVRCP.
   3. Connection is maintained.

Handsfree Phone A2DP/AVRCP 1.4 Connection
Device Profiles DUT supports HFP and A2DP and AVRCP 1.4
TBD Validate that VCS is able to establish an HFP, A2DP, and AVRCP connection with the DUT.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. Media is present on the DUT (at least A tracks, B albums, and C artists) In one illustrative embodiment, A=50, B and C=10, although this number may be adjusted as needed
Procedure 1. Suspend VCS.
   2. Verify that VCS disconnects from the device.
   3. Resume VCS.
   4. If music does not resume playing, press play within VCS menu.
   5. Verify that meta-data of current playing track is displayed via VCS.
   6. Select a track via the Browse menu within VCS.
   7. Verify that the selected track begins playing and that the correct meta-data is displayed.
   8. Repeat sufficient additional times.
Expected Result 1. Media does not continue to play upon disconnect.
   2. Upon resume, VCS establishes connection with DUT for HFP, A2DP, and AVRCP.
   3. Meta-data is displayed for current playing tracks.
   4. Connection is maintained.

Handsfree Phone, A2DP/AVRCP (1.0, 1.3, or 1.4), and Personal Area Networking
Device Profiles DUT supports HFP, A2DP, AVRCP (1.0, 1.3, or 1.4), and Personal Area

### Networking

TBD Validate that VCS is able to establish an HFP, A2DP, AVRCP, and PAN connection with the DUT.
Pre-Test Condition 1. DUT and VCS have been paired and connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. Media is present on the DUT (at least A tracks, B albums, and C artists) In one illustrative embodiment, A=50, B and C=10, although this number may be adjusted as needed
   8. Repeat sufficient additional times.
Procedure 1. Suspend VCS.
   2. Verify that VCS disconnects from the device.
   3. Resume VCS.
   4. If music does not resume playing, press play within VCS menu.
   5. Verify that meta-data of current playing track is displayed via VCS (if AVRCP 1.3 or greater is supported).
   6. Select a track via the Browse menu within VCS (if AVRCP 1.4 is supported. If DUT is AVRCP 1.3 or below, select next track).
   7. Verify that the selected track begins playing and that the correct meta-data is displayed (if AVRCP 1.3 or greater is supported).
   8. Verify that PAN is connected (via Phone HMI)
Expected Result 1. Media does not continue to play upon disconnect.
   2. Upon resume, VCS establishes connection with DUT for HFP, A2DP, AVRCP (1.0, 1.3, or 1.4), and PAN.
   3. Meta-data is displayed for current playing tracks (if AVRCP 1.3 or greater is supported).
   4. Connection is maintained.

Handsfree Phone, A2DP, AVRCP (1.0, 1.3, or 1.4), PAN and MAP
Device Profiles DUT supports HFP, A2DP, AVRCP (1.0, 1.3, or 1.4), Personal Area Networking, and Message Access Profile
TBD Validate that VCS is able to establish an HFP, A2DP, AVRCP, PAN, and MAP connection with the DUT.
Pre-Test Condition 1. DUT and VCS have been paired and connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least N tracks stored. In one illustrative embodiment N=5.
Procedure 1. Suspend VCS.
   2. Verify that VCS disconnects from the device.
   3. Resume VCS.
   4. Send a text message to the device under test.
   5. Verify that VCS notifies user of the new incoming text message.
   6. If music does not resume playing, press play within VCS menu.
   7. Verify that meta-data of current playing track is displayed via VCS (if AVRCP 1.3 or greater is supported).
   8. Select a track via the Browse menu within VCS (if AVRCP 1.4 is supported. If DUT is AVRCP 1.3 or below, select next track).
   9. Verify that the selected track begins playing and that the correct meta-data is displayed (if AVRCP 1.3 or greater is supported).
   10. Verify that PAN is connected (via Phone HMI)
   11. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PAN.
   3. Meta-data is displayed for current playing tracks (if AVRCP 1.3 or greater is supported).
   4. VCS notifies user of newly received text message.
   5. Connection is maintained.

Handsfree Phone, A2DP, AVRCP (1.0, 1.3, or 1.4), PAN, and PBAP
Device Profiles DUT supports HFP, A2DP, AVRCP (1.0, 1.3, or 1.4), Personal Area Networking, and Phonebook Access Profile and/or VCSML.
TBD Validate that VCS is able to establish an HFP, A2DP, AVRCP, PBAP, and PAN, connection with the DUT.
Pre-Test Condition 1. DUT and VCS have been paired and is connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least X phonebook contacts stored within its memory. In one illustrative embodiment, X=100.
   8. Phonebook within VCS has been deleted.
   9. DUT has at least N tracks stored. In one illustrative embodiment, N=5.
Procedure 1. Suspend VCS.
   2. Verify that VCS disconnects from the device.
   3. Resume VCS.
   4. Within the phonebook tab, verify that the phonebook has been downloaded.
   5. If music does not resume playing, press play within VCS menu.
   6. Verify that meta-data of current playing track is displayed via VCS (if AVRCP 1.3 or greater is supported).
   7. Select a track via the Browse menu within VCS (if AVRCP 1.4 is supported. If DUT is AVRCP 1.3 or below, select next track).
   8. Verify that the selected track begins playing and that the correct meta-data is displayed (if AVRCP 1.3 or greater is supported).
   9. Verify that PAN is connected (via Phone HMI)
   10. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PAN.
   3. Meta-data is displayed for current playing tracks (if AVRCP 1.3 or greater is supported).
   4. Phonebook contacts from the DUT are present within VCS
   5. Connection is maintained.

Handsfree Phone, A2DP, AVRCP (1.0, 1.3, or 1.4), PAN, MAP, and PBAP
Device Profiles DUT supports HFP, A2DP, AVRCP (1.0, 1.3, or 1.4), Personal Area Networking, Message Access Profile, and Phonebook Access Profile and/or VCSML.
TBD Validate that VCS is able to establish an HFP, A2DP, AVRCP, PBAP, PAN, and MAP connection with the DUT.
Pre-Test Condition 1. DUT and VCS have been paired and is connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least X phonebook contacts stored within its memory. In one illustrative embodiment, X=100.
   8. Phonebook within VCS has been deleted.
   9. DUT has at least N tracks stored. In one illustrative embodiment, N=5.
Procedure 1. Suspend VCS.
   2. Verify that VCS disconnects from the device.
   3. Resume VCS.
   4. Send a text message to the device under test.
   5. Verify that VCS notifies user of the new incoming text message.
   6. Within the phonebook tab, verify that the phonebook has been downloaded.
   7. If music does not resume playing, press play within VCS menu.
   8. Verify that meta-data of current playing track is displayed via VCS (if AVRCP 1.3 or greater is supported).
   9. Select a track via the Browse menu within VCS (if AVRCP 1.4 is supported. If DUT is AVRCP 1.3 or below, select next track).
   10. Verify that the selected track begins playing and that the correct meta-data is displayed (if AVRCP 1.3 or greater is supported).
   11. Verify that PAN is connected (via Phone HMI)
   12. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PAN.
   3. Meta-data is displayed for current playing tracks (if AVRCP 1.3 or greater is supported).
   4. VCS notifies user of newly received text message.
   5. Phonebook contacts from the DUT are present within VCS
   6. Connection is maintained.

Handsfree Phone, A2DP, AVRCP (1.0, 1.3, or 1.4), MAP, and PBAP
Device Profiles DUT supports HFP, A2DP, AVRCP (1.0, 1.3, or 1.4), Message Access Profile, and Phonebook Access Profile and/or VCSML.
TBD Validate that VCS is able to establish an HFP, A2DP, AVRCP, PBAP, and MAP connection with the DUT.
Pre-Test Condition 1. DUT and VCS have been paired and is connected.
   2. DUT shall be set to ‘Favorite’ phone.
   3. Auto-Phonebook Download is set to ON.
   4. DUT is streaming audio to VCS via A2DP.
   5. DUT has at least X phonebook contacts stored within its memory. In one illustrative embodiment, X=100.
   6. Phonebook within VCS has been deleted.
   7. DUT has at least N tracks stored. In one illustrative embodiment, N=5.
Procedure 1. Suspend VCS.
   2. Verify that VCS disconnects from the device.
   3. Resume VCS.
   4. Send a text message to the device under test.
   5. Verify that VCS notifies user of the new incoming text message.
   6. Within the phonebook tab, verify that the phonebook has been downloaded.
   7. If music does not resume playing, press play within VCS menu.
   8. Verify that meta-data of current playing track is displayed via VCS (if AVRCP 1.3 or greater is supported).
   9. Select a track via the Browse menu within VCS (if AVRCP 1.4 is supported. If DUT is AVRCP 1.3 or below, select next track).
   10. Verify that the selected track begins playing and that the correct meta-data is displayed (if AVRCP 1.3 or greater is supported).
   11. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), MAP, and PBAP.
   3. Meta-data is displayed for current playing tracks (if AVRCP 1.3 or greater is supported).
   4. VCS notifies user of newly received text message.
   5. Phonebook contacts from the DUT are present within VCS
   6. Connection is maintained.

Handsfree Phone, A2DP, AVRCP (1.0, 1.3, or 1.4), and PBAP
Device Profiles DUT supports HFP, A2DP, AVRCP (1.0, 1.3, or 1.4), and Phonebook Access Profile, and/or VCSML.
TBD Validate that VCS is able to establish an HFP, A2DP, AVRCP, and PBAP connection with the DUT.
Pre-Test Condition 1. DUT and VCS have been paired and is connected.
   2. DUT shall be set to ‘Favorite’ phone.
   3. Auto-Phonebook Download is set to ON.
   4. DUT is streaming audio to VCS via A2DP.
   5. DUT has at least X phonebook contacts stored within its memory. In one illustrative embodiment, X=100.
   6. Phonebook within VCS has been deleted.
   7. DUT has at least N tracks stored. In one illustrative embodiment, N=5.
Procedure 1. Suspend VCS.
   2. Verify that VCS disconnects from the device.
   3. Resume VCS.
   4. Within the phonebook tab, verify that the phonebook has been downloaded.
   5. If music does not resume playing, press play within VCS menu.
   6. Verify that meta-data of current playing track is displayed via VCS (if AVRCP 1.3 or greater is supported).
   7. Select a track via the Browse menu within VCS (if AVRCP 1.4 is supported. If DUT is AVRCP 1.3 or below, select next track).
   8. Verify that the selected track begins playing and that the correct meta-data is displayed (if AVRCP 1.3 or greater is supported).
   9. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PBAP.
   3. Meta-data is displayed for current playing tracks (if AVRCP 1.3 or greater is supported).
   4. Phonebook contacts from the DUT are present within VCS
   5. Connection is maintained.

Handsfree Phone and PBAP
Device Profiles DUT supports HFP and Phonebook Access Profile, and/or VCSML.
TBD Validate that VCS is able to establish an HFP and PBAP connection with the DUT.
Pre-Test Condition 1. DUT and VCS have been paired and is connected.
   2. DUT shall be set to ‘Favorite’ phone.
   3. Auto-Phonebook Download is set to ON.
   4. DUT has at least X phonebook contacts stored within its memory. In one illustrative embodiment, X=100.
   5. Phonebook within VCS has been deleted.
Procedure 1. Suspend VCS.
   2. Verify that VCS disconnects from the device.
   3. Resume VCS.
   4. Within the phonebook tab, verify that the phonebook has been downloaded.
   5. Repeat sufficient additional times.
Expected Result 1. Upon Resume, VCS establishes a connection with the DUT for Handsfree Profile and Phonebook Access Profile.
   2. Phonebook contacts from the DUT are present within VCS
   3. Connection is maintained.

Handsfree Phone, PBAP, and MAP
Device Profiles DUT supports HFP, Message Access Profile, and Phonebook Access Profile, and/or VCSML.
TBD Validate that VCS is able to establish an HFP, PBAP, and MAP connection with the DUT.
Pre-Test Condition 1. DUT and VCS have been paired and is connected.
   2. DUT shall be set to ‘Favorite’ phone.
   3. Auto-Phonebook Download is set to ON.
   4. DUT has at least X phonebook contacts stored within its memory. In one illustrative embodiment, X=100.
   5. Phonebook within VCS has been deleted.
Procedure 1. Suspend VCS.
   2. Verify that VCS disconnects from the device.
   3. Resume VCS.
   4. Send a text message to the device under test.
   5. Verify that VCS notifies user of the new incoming text message.
   6. Within the phonebook tab, verify that the phonebook has been downloaded.
   7. Repeat sufficient additional times.
Expected Result 1. Upon resume, VCS establishes connection with DUT for HFP, MAP, and PBAP.
   2. VCS notifies user of newly received text message.
   3. Phonebook contacts from the DUT are present within VCS
   4. Connection is maintained.

Handsfree Phone Connection
Device Profiles DUT supports: HFP only
TBD Validate VCS initiated connection between the device under test. Validate that an active phone call on the DUT becomes a Handsfree call.
Pre-Test Condition 1. DUT and VCS have been paired.
   2. DUT shall be set to ‘Favorite’ phone.
   3. Auto-Phonebook Download is set to ON.
   4. VCS is set to suspend (i.e. off)
   5. DUT is on.
   6. Bluetooth on DUT is set to ON.
   7. DUT is in an active call.
   8. Repeat steps above sufficient additional times
Procedure 1. Switch VCS from suspended state to resume state (i.e. on)
Expected Result 1. VCS shall establish a connection to the DUT and remain connected.
   2. The active call shall become a Handsfree Call.

Handsfree Phone and A2DP/AVRCP 1.0 Connection
Device Profiles DUT supports HFP and A2DP and AVRCP 1.0
TBD Validate that VCS is able to establish an HFP, A2DP, and AVRCP connection with the DUT.
   Validate that an active phone call on the DUT becomes a Handsfree call.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. Repeat sufficient additional times.
Procedure 1. Suspend VCS.
   2. Verify that VCS disconnects from the device.
   3. Initiate an active call on the DUT.
   4. Resume VCS.
   5. Verify that the active call becomes a Handsfree Call.
   6. End the call via VCS.
   7. If music does not resume playing, press play within VCS menu. It maybe necessary to open the media player on the DUT.
   8. Press Next Track to confirm AVRCP connection.
Expected Result 1. Media does not continue to play upon disconnect.
   2. Upon resume, VCS establishes connection with DUT for HFP, A2DP, and AVRCP.
   3. Active call on DUT becomes Handsfree call.
   4. Connection is maintained.

Handsfree Phone and A2DP/AVRCP 1.3 Connection
Device Profiles DUT supports HFP and A2DP and AVRCP 1.3
TBD Validate that VCS is able to establish an HFP, A2DP, and AVRCP connection with the DUT.
   Validate that an active phone call on the DUT becomes a Handsfree call.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. DUT has at least N media tracks stored. In one illustrative embodiment, N=5.
   6. Repeat sufficient additional times.
Procedure 1. Suspend VCS.
   2. Verify that VCS disconnects from the device.
   3. Initiate call on DUT
   4. Resume VCS.
   5. Verify that active call becomes Handsfree call.
   6. End call via VCS.
   7. If music does not resume playing, press play within VCS menu. It maybe necessary to begin media player on device.
   8. Verify that meta-data of current playing track is displayed via VCS.
   9. Press Next Track via VCS.
Expected Result 1. Media does not continue to play upon disconnect.
   2. Upon resume, VCS establishes connection with DUT for HFP, A2DP, and AVRCP.
   3. Active call becomes Handsfree call.
   4. Connection is maintained.

Handsfree Phone and A2DP/AVRCP 1.4 Connection
Device Profiles DUT supports HFP and A2DP and AVRCP 1.4
TBD Validate that VCS is able to establish an HFP, A2DP, and AVRCP connection with the DUT.
Validate that an active phone call on the DUT becomes a Handsfree call.
Pre-Test Condition 1. DUT and VCS have been paired and connected.
   2. DUT shall be set to ‘Favorite’ phone.
   3. Auto-Phonebook Download is set to ON.
   4. DUT is streaming audio to VCS via A2DP.
   5. Media is present on the DUT (at least A tracks, B albums, and C artists) In one illustrative embodiment, A=50, B and C=10, although this number may be adjusted as needed
Procedure 1. Suspend VCS.
   2. Verify that VCS disconnects from the device.
   3. Initiate call via DUT.
   4. Resume VCS.
   5. Verify that active call becomes Handsfree call.
   6. End call via VCS.
   7. If music does not resume playing, press play within VCS menu. It maybe necessary to begin the media player on the device.
   8. Verify that meta-data of current playing track is displayed via VCS.
   9. Select a track via the Browse menu within VCS.
   10. Verify that the selected track begins playing and that the correct meta-data is displayed.
   11. Repeat sufficient additional times.
Expected Result 1. Media does not continue to play upon disconnect.
   2. Upon resume, VCS establishes connection with DUT for HFP, A2DP, and AVRCP.
   3. Verify active call becomes Handsfree call.
   4. Meta-data is displayed for current playing tracks.
   5. Connection is maintained.

Handsfree Phone, A2DP/AVRCP (1.0, 1.3, or 1.4), and Personal Area Networking
Device Profiles DUT supports HFP, A2DP, AVRCP (1.0, 1.3, or 1.4), and Personal Area Networking
TBD Validate that VCS is able to establish an HFP, A2DP, AVRCP, and PAN connection with the DUT.
   Validate that an active phone call on the DUT becomes a Handsfree call.
Pre-Test Condition 1. DUT and VCS have been paired and connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. Media is present on the DUT (at least A tracks, B albums, and C artists) In one illustrative embodiment, A=50, B and C=10, although this number may be adjusted as needed
   8. Repeat sufficient additional times.
Procedure 1. Suspend VCS.
   2. Verify that VCS disconnects from the device.
   3. Initiate call via DUT
   4. Resume VCS.
   5. Verify that active call becomes Handsfree call.
   6. End call via VCS.
   7. If music does not resume playing, press play within VCS menu. It maybe necessary to begin the media player on the device.
   8. Verify that meta-data of current playing track is displayed via VCS (if AVRCP 1.3 or greater is supported).
   9. Select a track via the Browse menu within VCS (if AVRCP 1.4 is supported. If DUT is AVRCP 1.3 or below, select next track).
   10. Verify that the selected track begins playing and that the correct meta-data is displayed (if AVRCP 1.3 or greater is supported).
   11. Verify that PAN is connected (via Phone HMI)
Expected Result 1. Media does not continue to play upon disconnect.
   2. Upon resume, VCS establishes connection with DUT for HFP, A2DP, AVRCP (1.0, 1.3, or 1.4), and PAN.
   3. Verify that the active call becomes a Handsfree call.
   4. Meta-data is displayed for current playing tracks (if AVRCP 1.3 or greater is supported).
   5. Connection is maintained.

Handsfree Phone, A2DP, AVRCP (1.0, 1.3, or 1.4), PAN, and MAP
Device Profiles DUT supports HFP, A2DP, AVRCP (1.0, 1.3, or 1.4), Personal Area Networking, and Message Access Profile
TBD Validate that VCS is able to establish an HFP, A2DP, AVRCP, PAN, and MAP connection with the DUT.
Validate that an active phone call on the DUT becomes a Handsfree call.
Pre-Test Condition 1. DUT and VCS have been paired and connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least N tracks stored. In a preferred embodiment, N=5.
Procedure 1. Suspend VCS.
   2. Verify that VCS disconnects from the device.
   3. Initiate a call via DUT
   4. Resume VCS.
   5. Verify that the active call becomes a Handsfree call.
   6. End the call via VCS.
   7. Send a text message to the device under test.
   8. Verify that VCS notifies user of the new incoming text message.
   9. If music does not resume playing, press play within VCS menu.
   10. Verify that meta-data of current playing track is displayed via VCS (if AVRCP 1.3 or greater is supported).
   11. Select a track via the Browse menu within VCS (if AVRCP 1.4 is supported. If DUT is AVRCP 1.3 or below, select next track).
   12. Verify that the selected track begins playing and that the correct meta-data is displayed (if AVRCP 1.3 or greater is supported).
   13. Verify that PAN is connected (via Phone HMI)
   14. Repeat sufficient additional times.
Expected Result 6. Media does not continue to play upon disconnect.
   7. Upon resume, VCS establishes connection with DUT for HFP, A2DP, AVRCP (1.0, 1.3, or 1.4), and PAN.
   8. Verify that the active call becomes a Handsfree call.
   9. Meta-data is displayed for current playing tracks (if AVRCP 1.3 or greater is supported).
   10. VCS notifies user of newly received text message.
   11. Connection is maintained.

Handsfree Phone, A2DP, AVRCP (1.0, 1.3, or 1.4), PAN, and PBAP
Device Profiles DUT supports HFP, A2DP, AVRCP (1.0, 1.3, or 1.4), Personal Area Networking, and Phonebook Access Profile and/or VCSML.
TBD Validate that VCS is able to establish an HFP, A2DP, AVRCP, PBAP, and PAN, connection with the DUT.
Pre-Test Condition 1. DUT and VCS have been paired and is connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least X phonebook contacts stored within its' memory. In one illustrative example X=100.
   8. Phonebook within VCS has been deleted.
   9. DUT has at least N tracks stored. In one illustrative example, N=5.
Procedure 1. Suspend VCS.
   2. Verify that VCS disconnects from the device.
   3. Initiate a call via the DUT
   4. Resume VCS.
   5. Verify that the active call becomes a Handsfree call.
   6. End the call via VCS.
   7. Within the phonebook tab, verify that the phonebook has been downloaded.
   8. If music does not resume playing, press play within VCS menu.
   9. Verify that meta-data of current playing track is displayed via VCS (if AVRCP 1.3 or greater is supported).
   10. Select a track via the Browse menu within VCS (if AVRCP 1.4 is supported. If DUT is AVRCP 1.3 or below, select next track).
   11. Verify that the selected track begins playing and that the correct meta-data is displayed (if AVRCP 1.3 or greater is supported).
   12. Verify that PAN is connected (via Phone HMI)
   13. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PAN.
   3. Active call becomes Handsfree call.
   4. Meta-data is displayed for current playing tracks (if AVRCP 1.3 or greater is supported).
   5. Phonebook contacts from the DUT are present within VCS
   6. Connection is maintained.

Handsfree Phone, A2DP, AVRCP (1.0, 1.3, or 1.4), PAN, MAP, and PBAP
Device Profiles DUT supports HFP, A2DP, AVRCP (1.0, 1.3, or 1.4), Personal Area Networking, Message Access Profile, and Phonebook Access Profile
TBD Validate that VCS is able to establish an HFP, A2DP, AVRCP, PBAP, PAN, and MAP connection with the DUT.
   Validate that an active phone call on the DUT becomes a Handsfree call.
Pre-Test Condition 1. DUT and VCS have been paired and is connected.
   2. DUT shall be set to ‘Favorite’ phone.
   3. Auto-Phonebook Download is set to ON.
   4. PAN ‘Always Connect’ has been selected.
   5. PAN is connected.
   6. DUT is streaming audio to VCS via A2DP.
   7. DUT has at least X phonebook contacts stored within its' memory.
   8. Phonebook within VCS has been deleted.
   9. DUT has at least N tracks stored.
Procedure 1. Suspend VCS.
   2. Verify that VCS disconnects from the device.
   3. Initiate a call via the DUT
   4. Resume VCS.
   5. Verify that the active call becomes a Handsfree call.
   6. End the call via VCS.
   7. Send a text message to the device under test.
   8. Verify that VCS notifies user of the new incoming text message.
   9. Within the phonebook tab, verify that the phonebook has been downloaded.
   10. If music does not resume playing, press play within VCS menu. It maybe necessary to begin the media player on the DUT.
   11. Verify that meta-data of current playing track is displayed via VCS (if AVRCP 1.3 or greater is supported).
   12. Select a track via the Browse menu within VCS (if AVRCP 1.4 is supported. If DUT is AVRCP 1.3 or below, select next track).
   13. Verify that the selected track begins playing and that the correct meta-data is displayed (if AVRCP 1.3 or greater is supported).
   14. Verify that PAN is connected (via Phone HMI)
   15. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PAN.
   3. Active call becomes Handsfree call.
   4. Meta-data is displayed for current playing tracks (if AVRCP 1.3 or greater is supported).
   5. VCS notifies user of newly received text message.
   6. Phonebook contacts from the DUT are present within VCS
   7. Connection is maintained.

Handsfree Phone, A2DP, AVRCP (1.0, 1.3, or 1.4), MAP, and PBAP
Device Profiles DUT supports HFP, A2DP, AVRCP (1.0, 1.3, or 1.4), Message Access Profile, and Phonebook Access Profile
TBD Validate that VCS is able to establish an HFP, A2DP, AVRCP, PBAP, and MAP connection with the DUT.
   Validate that an active phone call on the DUT becomes a Handsfree call.
Pre-Test Condition 1. DUT and VCS have been paired and is connected.
   2. DUT shall be set to ‘Favorite’ phone.
   3. Auto-Phonebook Download is set to ON.
   4. DUT is streaming audio to VCS via A2DP.
   5. DUT has at least X phonebook contacts stored within its' memory.
   6. Phonebook within VCS has been deleted.
   7. DUT has at least N tracks stored.
Procedure 1. Suspend VCS.
   2. Verify that VCS disconnects from the device.
   3. Initiate a call via the DUT.
   4. Resume VCS.
   5. Verify that the active call becomes a Handsfree call.
   6. End call via VCS.
   7. Send a text message to the device under test.
   8. Verify that VCS notifies user of the new incoming text message.
   9. Within the phonebook tab, verify that the phonebook has been downloaded.
   10. If music does not resume playing, press play within VCS menu. It maybe necessary to begin the media player on the DUT.
   11. Verify that meta-data of current playing track is displayed via VCS (if AVRCP 1.3 or greater is supported).
   12. Select a track via the Browse menu within VCS (if AVRCP 1.4 is supported. If DUT is AVRCP 1.3 or below, select next track).
   13. Verify that the selected track begins playing and that the correct meta-data is displayed (if AVRCP 1.3 or greater is supported).
   14. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), MAP, and PBAP.
   3. Active call becomes Handsfree call.
   4. Meta-data is displayed for current playing tracks (if AVRCP 1.3 or greater is supported).
   5. VCS notifies user of newly received text message.
   6. Phonebook contacts from the DUT are present within VCS
   7. Connection is maintained.

Handsfree Phone, A2DP, AVRCP (1.0, 1.3, or 1.4), and PBAP
Device Profiles DUT supports HFP, A2DP, AVRCP (1.0, 1.3, or 1.4), and Phonebook Access Profile
TBD Validate that VCS is able to establish an HFP, A2DP, AVRCP, and PBAP connection with the DUT.
   Validate that an active phone call on the DUT becomes a Handsfree call.
Pre-Test Condition 1. DUT and VCS have been paired and is connected.
   2. DUT shall be set to ‘Favorite’ phone.
   3. Auto-Phonebook Download is set to ON.
   4. DUT is streaming audio to VCS via A2DP.
   5. DUT has at least X phonebook contacts stored within its' memory.
   6. Phonebook within VCS has been deleted.
   7. DUT has at least N tracks stored.
Procedure 1. Suspend VCS.
   2. Verify that VCS disconnects from the device.
   3. Initiate a phone call from the DUT.
   4. Resume VCS.
   5. Verify that the active phone call becomes a Handsfree call.
   6. End the call via VCS.
   7. Within the phonebook tab, verify that the phonebook has been downloaded.
   8. If music does not resume playing, press play within VCS menu.
   9. Verify that meta-data of current playing track is displayed via VCS (if AVRCP 1.3 or greater is supported).
   10. Select a track via the Browse menu within VCS (if AVRCP 1.4 is supported. If DUT is AVRCP 1.3 or below, select next track).
   11. Verify that the selected track begins playing and that the correct meta-data is displayed (if AVRCP 1.3 or greater is supported).
   12. Repeat sufficient additional times.
Expected Result 1. Media does not continue to play upon disconnect.
   2. Upon resume, VCS establishes connection with DUT for HFP, A2DP, AVRCP (1.0, 1.3, or 1.4), and PBAP.
   3. The active call shall become a Handsfree call.
   4. Meta-data is displayed for current playing tracks (if AVRCP 1.3 or greater is supported).
   5. Phonebook contacts from the DUT are present within VCS
   6. Connection is maintained.

Handsfree Phone and PBAP
Device Profiles DUT supports HFP and Phonebook Access Profile
TBD Validate that VCS is able to establish an HFP and PBAP connection with the DUT.
   Validate that an active phone call on the DUT becomes a Handsfree call.
Pre-Test Condition 1. DUT and VCS have been paired and is connected.
   2. DUT shall be set to ‘Favorite’ phone.
   3. Auto-Phonebook Download is set to ON.
   4. DUT has at least X phonebook contacts stored within its' memory.
   5. Phonebook within VCS has been deleted.
Procedure 1. Suspend VCS.
   2. Verify that VCS disconnects from the device.
   3. Initiate a phone call from the DUT.
   4. Resume VCS.
   5. Verify that the phone call becomes a Handsfree call.
   6. End the call via VCS.
   7. Within the phonebook tab, verify that the phonebook has been downloaded.
   8. Repeat sufficient additional times.
Expected Result 1. Upon Resume, VCS establishes a connection with the DUT for Handsfree Profile and Phonebook Access Profile.
   2. Active phone call shall become a Handsfree call.
   3. Phonebook contacts from the DUT are present within VCS
   4. Connection is maintained.

Handsfree Phone, PBAP, and MAP
Device Profiles DUT supports HFP, Message Access Profile, and Phonebook Access Profile
TBD Validate that VCS is able to establish an HFP, PBAP, and MAP connection with the DUT.
   Validate that an active phone call on the DUT becomes a Handsfree call.
Pre-Test Condition 1. DUT and VCS have been paired and is connected.
   2. DUT shall be set to ‘Favorite’ phone.
   3. Auto-Phonebook Download is set to ON.
   4. DUT has at least X phonebook contacts stored within its' memory.
   5. Phonebook within VCS has been deleted.
Procedure 1. Suspend VCS.
   2. Verify that VCS disconnects from the device.
   3. Initiate a call from the DUT.
   4. Resume VCS.
   5. Verify that the active call becomes a Handsfree call.
   6. End call via VCS.
   7. Send a text message to the device under test.
   8. Verify that VCS notifies user of the new incoming text message.
   9. Within the phonebook tab, verify that the phonebook has been downloaded.
   10. Repeat sufficient additional times.
Expected Result 1. Upon resume, VCS establishes connection with DUT for HFP, MAP, and PBAP.
   2. Active call becomes a Handsfree call.
   3. VCS notifies user of newly received text message.
   4. Phonebook contacts from the DUT are present within VCS
   5. Connection is maintained.

Simulated Power Loss
Device Profiles DUT supports HFP
TBD Validate that VCS is able to re-establish an HFP connection with the DUT.
Pre-Test Condition 1. DUT and VCS have been paired and is connected.
   2. DUT shall be set to ‘Favorite’ phone.
   3. Auto-Phonebook Download is set to ON.
   4. DUT has at least 100 phonebook contacts stored within its' memory.
Procedure 1. Remove the battery from the DUT.
   2. Replace the battery in the DUT.
   3. Power up the DUT
Expected Result 1. Verify that VCS reconnects to the DUT for Handsfree Profile.

Automatic Disconnection
Device Profiles DUT supports HFP
TBD Validate that VCS is able to disconnect from the DUT.
Pre-Test Condition 1. DUT and VCS have been paired and is connected.
Procedure 1. Place VCS into suspend
Expected Result 1. VCS shall disconnect all profiles from the DUT.

In a second set of tests, the ability of a VCS to information pertaining to a DUT is tested.

Signal Strength
Device Profiles DUT supports HFP
TBD Validate that VCS is able to show the signal strength of the DUT.
Pre-Test Condition 1. DUT and VCS have been paired and is connected.
Procedure 1. Verify that VCS is displaying the signal strength of DUT.
Expected Result 1. VCS shall report the current signal strength of the DUT.

Battery Strength
Device Profiles DUT supports HFP
TBD Validate that VCS is able to show the battery strength of the DUT.
Pre-Test Condition 1. DUT and VCS have been paired and is connected.
Procedure 1. Verify that VCS is displaying the battery strength of DUT.
Expected Result 1. VCS shall report the current battery strength of the DUT.

Roaming Indicator
Device Profiles DUT supports HFP
TBD Validate that VCS is able to show the current roaming status of the DUT
Pre-Test Condition 1. DUT and VCS have been paired and is connected.
   2. The DUT is roaming
Procedure 1. Verify that VCS is displaying the current roaming status of the DUT.
Expected Result 1. VCS shall report the current roaming status of the DUT.

Carrier Reporting
Device Profiles DUT supports HFP
TBD Validate that VCS is able to show the current carrier of the DUT
Pre-Test Condition 1. DUT and VCS have been paired and is connected.
Procedure 1. Verify that VCS is displaying the current carrier of the DUT.
Expected Result 1. VCS shall report the current carrier of the DUT.

Device S/W Reporting
Device Profiles DUT supports HFP
TBD Validate that VCS is able to show the software version of the DUT.
Pre-Test Condition 1. DUT and VCS have been paired and is connected.
Procedure 1. Verify that VCS is displaying the software version of DUT.
Expected Result 1. VCS shall report the current software version of the DUT.

In a third illustrative embodiment, an illustrative series of tests tests the phone book capabilities of the VCS in conjunction with the device.

Name and Phone Number Confirmation
Device Profiles DUT supports HFP
TBD Validate that VCS is able to display the name and phone numbers of the phonebook contacts of the DUT
Pre-Test Condition 1. DUT has at least X phonebook contacts stored within its' memory. In at least one example, X=100.
   When DUT is a smartphone:
      Load device with at least M contacts, in at least one example, M=1,000
      Each contact shall contain:
         Address
         Photo
         E-mail Address
         Birthday
         Cell, Home, Office/Work, and other phone numbers
   When DUT is a non-smartphone:
      Load device with at least Y contacts, in at least one example, Y=100.
      Each contact shall contain:
         Cell, Home, Office/Work, and other phone number
      Choose 1 contact per beginning letter to load with:
         Address
         Photo
         E-mail Address
         Birthday
Procedure 1. Place VCS into discoverable mode.
   2. Search for VCS from the device under test.
   3. Select VCS on the device and input the PIN.
   4. When prompted to download the phonebook, select yes.
   5. When prompted to confirm phone number, select OK.
   6. Verify that the phonebook has downloaded by selecting the phonebook tab within the VCS menu.
   7. View at least one contact per letter or 26 contacts (or another suitable number of contacts)
      When DUT is a smartphone:
         Choose 1 contact per letter (A, B, C, etc.) to confirm download
      When DUT is a non-smartphone:
         Choose the contacts with address, photo, etc.
   8. Disconnect VCS from the DUT.
   9. Delete at least some number of contacts and add at least some number of new contacts based on the criteria set within the pre-test condition based on the type of the DUT.
   10. Reconnect the DUT by selecting the device within the VCS Bluetooth connection menu.
   11. Verify that the deleted contacts are no longer within the VCS phonebook.
   12. Verify that the added contacts are present within the VCS phonebook.
Expected Result 1. The device under test shall pair and remain connected.
   2. That VCS is able to display the contact names and phone numbers of the contacts stored within the DUT.
   3. That VCS is able to display an updated phonebook upon a new connection.

Name, Phone Number, and Address Confirmation
Device Profiles DUT supports HFP and Phonebook Access Profile and/or VCSML
TBD Validate that VCS is able to display the name, phone numbers, and address of the phonebook contacts of the DUT
Pre-Test Condition 1. DUT has at least X phonebook contacts stored within its' memory.
   When DUT is a smartphone:
      Load device with at least M contacts
      Each contact shall contain:
         Address
         Photo
         E-mail Address
         Birthday
         Cell, Home, Office/Work, and other phone numbers
   When DUT is a non-smartphone:
      Load device with at least X contacts
      Each contact shall contain:
         Cell, Home, Office/Work, and other phone number
      Choose 1 contact per beginning letter to load with:
         Address
         Photo
         E-mail Address
         Birthday
Procedure 1. Place VCS into discoverable mode.
   2. Search for VCS from the device under test.
   3. Select VCS on the device and input the PIN.
   4. When prompted to download the phonebook, select yes.
   5. When prompted to confirm phone number, select OK.
   6. Verify that the phonebook has downloaded by selecting the phonebook tab within the VCS menu.
   7. View at least 26 contacts
      When DUT is a smartphone:
         Choose 1 contact per letter (A, B, C, etc.) to confirm download
      When DUT is a non-smartphone:
         Choose the contacts with address, photo, etc.
   8. Disconnect VCS from the DUT.
   9. Delete at least D contacts and add at least D new contacts based on the criteria set within the pre-test condition based on the type of the DUT.
   10. Reconnect the DUT by selecting the device within the VCS Bluetooth connection menu.
   11. Verify that the deleted contacts are no longer within the VCS phonebook.
      *Note: There maybe some time delay for the update to take place.
   12. Verify that the added contacts are present within the VCS phonebook
Expected Result 1. The device under test shall pair and remain connected.
   2. That VCS is able to display the contact names, phone numbers, and addresses of the contacts stored within the DUT.
   3. That VCS is able to display an updated phonebook upon a new connection.

Name, Phone Number, Address, E-Mail Address Confirmation
Device Profiles DUT supports HFP and Phonebook Access Profile and/or VCSML
TBD Validate that VCS is able to display the name, phone numbers, address, and e-mail address of the phonebook contacts of the DUT
Pre-Test Condition 1. DUT has at least X phonebook contacts stored within its' memory.
   When DUT is a smartphone:
      Load device with at least M contacts
      Each contact shall contain:
         Address
         Photo
         E-mail Address
         Birthday
         Cell, Home, Office/Work, and other phone numbers
   When DUT is a non-smartphone:
      Load device with at least X contacts
      Each contact shall contain:
         Cell, Home, Office/Work, and other phone number
      Choose 1 contact per beginning letter to load with:
         Address
         Photo
         E-mail Address
         Birthday
Procedure 1. Place VCS into discoverable mode.
   2. Search for VCS from the device under test.
   3. Select VCS on the device and input the PIN.
   4. When prompted to download the phonebook, select yes.
   5. When prompted to confirm phone number, select OK.
   6. Verify that the phonebook has downloaded by selecting the phonebook tab within the VCS menu.
   7. View at least 26 contacts
      When DUT is a smartphone:
         Choose 1 contact per letter (A, B, C, etc.) to confirm download
      When DUT is a non-smartphone:
         Choose the contacts with address, photo, etc.
   8. Disconnect VCS from the DUT.
   9. Delete at least D contacts and add at least D new contacts based on the criteria set within the pre-test condition based on the type of the DUT.
   10. Reconnect the DUT by selecting the device within the VCS Bluetooth connection menu.
   11. Verify that the deleted contacts are no longer within the VCS phonebook.
      *Note: There may be some time delay for the update to take place.
   12. Verify that the added contacts are present within the VCS phonebook
Expected Result 1. The device under test shall pair and remain connected.
   2. That VCS is able to display the contact names, phone numbers, addresses, and e-mail address of the contacts stored within the DUT.
   3. That VCS is able to display an updated phonebook upon a new connection.

Name, Phone Number, Address, E-Mail Address, and Photo Confirmation
Device Profiles DUT supports HFP and Phonebook Access Profile and/or VCSML
TBD Validate that VCS is able to display the name, phone numbers, address, e-mail address, and photo of the phonebook contacts of the DUT
Pre-Test Condition 1. DUT has at least X phonebook contacts stored within its' memory.
   When DUT is a smartphone:
      Load device with at least M contacts
      Each contact shall contain:
         Address
         Photo
         E-mail Address
         Birthday
         Cell, Home, Office/Work, and other phone numbers
   When DUT is a non-smartphone:
      Load device with at least X contacts
      Each contact shall contain:
         Cell, Home, Office/Work, and other phone number
      Choose 1 contact per beginning letter to load with:
         Address
         Photo
         E-mail Address
         Birthday
Procedure 1. Place VCS into discoverable mode.
   2. Search for VCS from the device under test.
   3. Select VCS on the device and input the PIN.
   4. When prompted to download the phonebook, select yes.
   5. When prompted to confirm phone number, select OK.
   6. Verify that the phonebook has downloaded by selecting the phonebook tab within the VCS menu.
   7. View at least 26 contacts
      When DUT is a smartphone:
         Choose 1 contact per letter (A, B, C, etc.) to confirm download
      When DUT is a non-smartphone:
         Choose the contacts with address, photo, etc.
   8. Document the time required to download the phonebook.
   9. Disconnect VCS from the DUT.
   10. Delete at least D contacts and add at least D new contacts based on the criteria set within the pre-test condition based on the type of the DUT.
   11. Reconnect the DUT by selecting the device within the VCS Bluetooth connection menu.
   12. Verify that the deleted contacts are no longer within the VCS phonebook.
      *Note: There may be some time delay for the update to take place.
   13. Verify that the added contacts are present within the VCS phonebook
Expected Result 1. The device under test shall pair and remain connected.
   2. That VCS is able to display the contact names, phone numbers, addresses, e-mail address, and photo of the contacts stored within the DUT.
   3. That VCS is able to display an updated phonebook upon a new connection.

Call History Download
Device Profiles DUT supports HFP
TBD Validate that VCS is able to display the call history of the DUT.
Pre-Test Condition 1. Load call history of the DUT with random phone numbers for each folder (outgoing, incoming, and missed). Make sure that there are at least Z entries in each category and that the same phone number is not listed consecutively within any folder. In one embodiment, Z=25.
Procedure 1. Place VCS into discoverable mode.
   2. Search for VCS from the device under test.
   3. Select VCS on the device and input the PIN.
   4. When prompted to download the phonebook, select yes.
   5. When prompted to confirm phone number, select OK.
   6. Verify that the call history has downloaded by selecting the phonebook tab within the VCS menu.
   7. Confirm that the calls are listed in chronological order with the most recent calls on top of the list.
   8. Disconnect VCS from the DUT.
   9. Delete at least D calls from each folder (outgoing, incoming, and missed) and add at least D new calls per folder.
   10. Reconnect the DUT by selecting the device within the VCS Bluetooth connection menu.
   11. Verify that the deleted call history entries are no longer within the VCS phonebook.
      *Note: There maybe some time delay for the update to take place.
   12. Verify that the added call history entries are present within the VCS phonebook.
Expected Result 1. The device under test shall pair and remain connected.
   2. That VCS is able to display the call history of the DUT in chronological order.
   3. That VCS is able to display an updated call history upon a new connection.

In still a further series of tests, the ability of a VCS to manage calls is tested. In this illustrative example, the calls come to a wireless device and the VCS handles the calls in some capacity.

Incoming Call Notification: Caller ID Available
Device Profiles DUT supports HFP
TBD Validate that VCS notifies the user of the phone number of the incoming call
Pre-Test Condition 1. DUT and VCS have been paired and is connected.
   2. Phonebook with photos has been downloaded and available within VCS.
   3. Display photos should be set to ‘ON’
Procedure 1. Place an incoming call to the DUT from a contact with a photo associated with it in VCS's phonebook (if photo transfer is supported by the DUT).
   2. Verify that VCS displays the phone number and photo (if photo transfer is supported by the DUT) of the incoming caller.
   3. Answer call via VCS.
   4. End the call via VCS.
   5. Repeat 4 additional times.
Expected Result 1. VCS shall display the phone number and photo (if photo transfer is supported by the DUT) of the incoming call.
   2. VCS shall ring to indicate that an incoming call is present
   3. VCS shall end the call on the DUT and shall not display any active calls.

Incoming Call Notification: Caller ID Not Available
Device Profiles DUT supports HFP
TBD Validate that VCS notifies the user of an incoming call
Pre-Test Condition 1. DUT and VCS have been paired and is connected.
Procedure 1. Place an incoming call to the DUT from a blocked phone number.
   2. Verify that VCS displays the ‘Unknown’ for the phone number of the incoming call.
   3. Answer the call via VCS
   4. End the call from the ‘far end’.
Expected Result 1. VCS shall display ‘Unknown’ for the phone number of the incoming call.
   2. VCS shall ring to indicate that an incoming call is present.
   3. VCS shall indicate that the call has ended, when user ends call from the ‘far end’.

In Band Ringing Support
Device Profiles DUT supports HFP
TBD Validate that VCS notifies the user of an incoming call with the ringtone of the DUT.
Pre-Test Condition 1. DUT and VCS have been paired and is connected.
   2. VCS ringtone is set to ‘Phone Ringer’
Procedure 1. Place an incoming call to the DUT from an available phone number.
   2. Verify that VCS displays the phone number of the incoming caller.
   3. Allow DUT to ring for at least 5 rings or until voicemail timeout.
   4. Verify that the ringtone played via VCS is the ringtone of the DUT
Expected Result 1. VCS shall display the phone number of the incoming call.
   2. VCS shall play the ringtone of the device to indicate that an incoming call is present

Call Reject Via VCS
Device Profiles DUT supports HFP
TBD Validate that VCS rejects an incoming call
Pre-Test Condition 1. DUT and VCS have been paired and is connected.
Procedure 1. Place an incoming call to the DUT from an available phone number.
   2. Verify that VCS displays the phone number of the incoming caller.
   3. Reject the call via VCS
   4. Repeat procedure a total of H times. In one illustrative embodiment, H=3.
Expected Result 1. VCS shall display the phone number of the incoming call.
   2. VCS shall ring to indicate that an incoming call is present
   3. VCS shall reject the incoming call and stop notifying the user of an incoming call.

Call Reject Via ‘do not Disturb’
Device Profiles DUT supports HFP
TBD Validate that VCS automatically rejects an incoming call
Pre-Test Condition 1. DUT and VCS have been paired and is connected.
   2. Do Not Disturb is set to ‘ON’
Procedure 1. Place an incoming call to the DUT from an available phone number.
   2. Repeat procedure a total of H times.
Expected Result 1. VCS shall not ring nor indicate an incoming call.
   2. VCS shall reject the incoming call.
   3. The DUT shall not ring more than 1 full ring

Call Reject Via DUT
Device Profiles DUT supports HFP
TBD Validate that VCS stops notifying the user of an incoming call when it is rejected via the DUT.
Pre-Test Condition 1. DUT and VCS have been paired and is connected.
Procedure 1. Place an incoming call to the DUT from an available phone number.
   2. Verify that VCS displays the phone number of the incoming caller.
   3. Allow the DUT to ring at least twice
   4. Reject the call via the DUT
   5. Repeat procedure a total of H times.
Expected Result 1. VCS shall display the phone number of the incoming call.
   2. VCS shall ring to indicate that an incoming call is present
   3. VCS shall stop ringing and notifying the user of an incoming call once it has been rejected via the DUT.

Call Answer Via VCS
Device Profiles DUT supports HFP
TBD Validate that a Handsfree call can be established when answering an incoming call via the VCS.
Pre-Test Condition 1. DUT and VCS have been paired and is connected.
Procedure 1. Place an incoming call to the DUT from an available phone number.
   2. Verify that VCS displays the phone number of the incoming caller.
   3. Answer call via VCS.
   4. End the call via VCS.
Expected Result 1. VCS shall display the phone number of the incoming call.
   2. VCS shall ring to indicate that an incoming call is present
   3. VCS shall answer the incoming call and the call shall be Handsfree.
   4. VCS shall end the call on the DUT and shall not display any active calls.

Call Answer Via DUT
Device Profiles DUT supports HFP
TBD Validate that a Handsfree call can be established when answering an incoming call via the DUT.
Pre-Test Condition 1. DUT and VCS have been paired and is connected.
Procedure 1. Place an incoming call to the DUT from an available phone number.
   2. Verify that VCS displays the phone number of the incoming caller.
   3. Answer call via DUT.
   4. Verify that a Handsfree call is present.
   5. End the call via VCS.
Expected Result 1. VCS shall display the phone number of the incoming call.
   2. VCS shall ring to indicate that an incoming call is present
   3. VCS shall establish a Handsfree call.
   4. VCS shall end the call on the DUT and shall not display any active calls.

No Answer
Device Profiles DUT supports HFP
TBD Validate that there are no negative effects of not answering an incoming call.
Pre-Test Condition 1. DUT and VCS have been paired and is connected.
Procedure 1. Place an incoming call to the DUT from an available phone number.
   2. Verify that VCS displays the phone number of the incoming caller.
Expected Result 1. VCS shall display the phone number of the incoming call.
   2. VCS shall ring to indicate that an incoming call is present
   3. VCS shall stop ringing and notifying the user of an incoming call once the device stops ringing.

Call Placed Via VCS
Device Profiles DUT supports HFP
TBD Validate that VCS can establish a Handsfree call.
Pre-Test Condition 1. DUT and VCS have been paired and is connected.
   2. Phonebook with photos has been downloaded and available within VCS.
   3. Display photos should be set to ‘ON’
Procedure 1. Via VCS, select a phonebook contact with a photo (if photo transfer is supported by the DUT).
   2. Verify that a Handsfree call is established.
   3. Verify that photo is displayed (if photo transfer is supported by the DUT).
   4. End the call via DUT.
Expected Result 1. A Handsfree call shall be established.
   2. The photo of the contact shall be displayed via VCS (if photo transfer is supported by the DUT)
   3. The DUT shall end the call and VCS shall indicate that the call was ended and no longer display any active calls.

Call Placed Via DUT
Device Profiles DUT supports HFP
TBD Validate that VCS will reflect that an active call has been established when call is initiated from the DUT.
Pre-Test Condition 1. DUT and VCS have been paired and is connected.
Procedure 1. Via the DUT, place an outgoing call.
   2. Verify that a Handsfree call is established.
   3. End the call via DUT.
Expected Result 1. A Handsfree call shall be established.
   2. The DUT shall end the call and VCS shall indicate that the call was ended and no longer display any active calls.

Redial
Device Profiles DUT supports HFP
TBD Validate that VCS can redial the last dialed number
Pre-Test Condition 1. DUT and VCS have been paired and is connected.
   2. DUT has outgoing calls within its' call history
Procedure 1. Press VCS's Dial button to initiate a redial.
   2. Confirm that a call is established to the last outgoing call listed within the DUT's outgoing call history.
   3. End call from the far end.
Expected Result 1. A Handsfree call shall be established to the last outgoing call listed in the DUT's outgoing call history.
   2. The DUT shall end the call and VCS shall indicate that the call was ended and no longer display any active calls.

Flip Phone Closed and Idle
Device Profiles DUT is a flip phone and supports HFP
TBD Validate that VCS can establish a Handsfree call.
Pre-Test Condition 1. DUT and VCS have been paired and is connected.
   2. Phonebook with photos has been downloaded and available within VCS.
   3. Display photos should be set to ‘ON’
   4. Phone is closed and idle.
Procedure 1. Via VCS, select a phonebook contact with a photo (if photo transfer is supported by the DUT).
   2. Verify that a Handsfree call is established.
   3. Verify that photo is displayed (if photo transfer is supported by the DUT).
   4. End the call via DUT.
Expected Result 1. A Handsfree call shall be established.
   2. The photo of the contact shall be displayed via VCS (if photo transfer is supported by the DUT)
   3. The DUT shall end the call and VCS shall indicate that the call was ended and no longer display any active calls.

Random Menu within DUT
Device Profiles DUT supports HFP
TBD Validate that VCS can establish a Handsfree call.
Pre-Test Condition 1. DUT and VCS have been paired and is connected.
   2. Phonebook with photos has been downloaded and available within VCS.
   3. Display photos should be set to ‘ON’
Procedure 1. Navigate DUT to random menu.
   2. Via VCS, select a phonebook contact with a photo (if photo transfer is supported by the DUT).
   3. Verify that a Handsfree call is established.
   4. Verify that photo is displayed (if photo transfer is supported by the DUT).
   5. End the call via DUT.
Expected Result 1. A Handsfree call shall be established.
   2. The photo of the contact shall be displayed via VCS (if photo transfer is supported by the DUT)
   3. The DUT shall end the call and VCS shall indicate that the call was ended and no longer display any active calls.

Text Message Received
Device Profiles DUT supports HFP
TBD Validate that VCS can establish a Handsfree call.
Pre-Test Condition 1. DUT and VCS have been paired and is connected.
   2. Phonebook with photos has been downloaded and available within VCS.
   3. Display photos should be set to ‘ON’
Procedure 1. Send a text message to the DUT.
   2. Don't read the text message, and allow the pop-up notification on the DUT to remain on the DUT's screen.
   3. Via VCS, select a phonebook contact with a photo (if photo transfer is supported by the DUT).
   4. Verify that a Handsfree call is established.
   5. Verify that photo is displayed (if photo transfer is supported by the DUT).
   6. End the call via DUT.
Expected Result 1. A Handsfree call shall be established.
   2. The photo of the contact shall be displayed via VCS (if photo transfer is supported by the DUT)
   3. The DUT shall end the call and VCS shall indicate that the call was ended and no longer display any active calls.

Transfer to Privacy (i.e. VCS Release SCO)
Device Profiles DUT supports HFP
TBD Validate that VCS can release SCO and transfer the audio to the DUT.
Pre-Test Condition 1. DUT and VCS have been paired and is connected.
Procedure 1. Place an outgoing call via VCS to another phone.
   2. Verify that a Handsfree call has been established.
   3. Via VCS, transfer the call to the DUT by pressing the Privacy button.
   4. Confirm that the audio was transferred to the DUT.
   5. Via VCS transfer the audio back to VCS by pressing the Privacy button.
   6. Confirm that the audio is transferred to VCS
   7. End the call via VCS.
Expected Result 1. A Handsfree call shall be established
   2. Audio shall be transferred to DUT.
   3. Audio shall be transferred to VCS.
   4. VCS shall end the call on the DUT and shall not display any active calls.

Transfer to Privacy (i.e. DUT Request SCO)
Device Profiles DUT supports HFP
TBD Validate that VCS can release SCO and transfer the audio to the DUT.
Pre-Test Condition 1. DUT and VCS have been paired and is connected.
Procedure 1. Place an outgoing call via VCS to another phone.
   2. Verify that a Handsfree call has been established.
   3. Via the DUT, transfer the call to the DUT.
   4. Confirm that the audio was transferred to the DUT.
   5. Via DUT transfer the audio back to VCS.
   6. Confirm that the audio is transferred to VCS
   7. End the call via VCS.
Expected Result 1. A Handsfree call shall be established
   2. Audio shall be transferred to DUT.
   3. Audio shall be transferred to VCS.
   4. VCS shall end the call on the DUT and shall not display any active calls.

Automatic Transfer to Privacy (i.e. VCS Release SCO)
Device Profiles DUT supports HFP
TBD Validate that VCS can release SCO and transfer the audio to the DUT.
Pre-Test Condition 1. DUT and VCS have been paired and is connected.
Procedure 1. Place an outgoing call via VCS to another phone.
   2. Verify that a Handsfree call has been established.
   3. Place VCS into suspend
Expected Result 1. A Handsfree call shall be established
   2. Audio shall be transferred to DUT

Incoming Call Waiting Call Answer Via VCS
Device Profiles DUT supports HFP
TBD Validate that VCS can indicate an incoming call waiting as well as update its' status that multiple calls are active when they are accepted via the VCS.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Answer the call waiting call, via VCS.
   7. Toggle between calls 1 and calls 2 by pressing the Dial button via VCS.
   8. Verify that active call indicated via VCS matches the active call each time the call is toggled via the Dial button.
   9. End one of the 2 calls via VCS, by pressing the End button.
   10. Verify that the remaining call becomes the active call.
Expected Result 1. A Handsfree call shall be established.
   2. An incoming call waiting notification shall be displayed. The photo of the contact shall be displayed via VCS (if photo transfer is supported by the DUT)
   3. VCS shall answer the incoming call waiting call.
   4. VCS shall toggle between both calls and display the correct active call as well as photo (if photo transfer is supported by the DUT).
   5. VCS shall end one of the active calls, and the remaining call shall become the active.*
   *Note: It is still considered a pass if the remaining call ‘rings’ as a new incoming phone call.

Incoming Call Waiting Call Answer Via DUT
Device Profiles DUT supports HFP
TBD Validate that VCS can indicate an incoming call waiting call as well as update its' status that multiple calls are active when they are accepted via the DUT.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS.
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Answer the call waiting call, via DUT.
   7. Toggle between calls 1 and calls 2 by pressing the Dial button via VCS.
   8. Verify that active call indicated via VCS matches the active call each time the call is toggled via the Dial button.
   9. End one of the 2 calls via VCS, by pressing the End button.
   10. Verify that the remaining call becomes the active call.
Expected Result 1. A Handsfree call shall be established.
   2. An incoming call waiting notification shall be displayed. The photo of the contact shall be displayed via VCS (if photo transfer is supported by the DUT)
   3. VCS shall answer the incoming call waiting call.
   4. VCS shall toggle between both calls and display the correct active call as well as photo (if photo transfer is supported by the DUT).
   5. VCS shall end one of the active calls, and the remaining call shall become the active.

Incoming Call Waiting Reject Via VCS
Device Profiles DUT supports HFP
TBD Validate that VCS can indicate an incoming call waiting as well as reject that call.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS.
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Reject the incoming call waiting call, via VCS.
Expected Result 1. A Handsfree call shall be established.
   2. An incoming call waiting notification shall be displayed. The photo of the contact shall be displayed via VCS (if photo transfer is supported by the DUT)
   3. VCS shall stop indicating that there is an incoming call waiting call.

Incoming Call Waiting Call Reject Via DUT
Device Profiles DUT supports HFP
TBD Validate that VCS can indicate an incoming call waiting as well as reject that call.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS.
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Reject the incoming call waiting call, via the DUT.
Expected Result 1. A Handsfree call shall be established.
   2. An incoming call waiting notification shall be displayed. The photo of the contact shall be displayed via VCS (if photo transfer is supported by the DUT)
   3. VCS shall stop indicating that there is an incoming call waiting call.

DTMF Tones
Device Profiles DUT supports HFP
TBD Validate that VCS can transmit DTMF tones.
Pre-Test Condition 1. DUT and VCS have been paired and is connected.
Procedure 1. Via VCS, call a phone number that will allow you to verify that DTMF tones are functioning properly.
   2. Verify that a Handsfree call is established.
   3. Send DTMF tones via VCS's keypad.
   4. Confirm that the DTMF's tones are properly received by the far end.
   5. End the call via DUT.
   6. Repeat procedure 2 additional times.
Expected Result 1. A Handsfree call shall be established.
   2. The correct DTMF tones shall be received by the far end
   3. The DUT shall end the call and VCS shall indicate that the call was ended and no longer display any active calls.

Placing a Call on Hold Via VCS
Device Profiles DUT supports HFP
TBD Validate that VCS can place and retrieve a Handsfree call from hold.
Pre-Test Condition 1. DUT and VCS have been paired and is connected.
   2. Phonebook with photos has been downloaded and available within VCS.
   3. Display photos should be set to ‘ON’
Procedure 1. Via VCS, select a phonebook contact with a photo (if photo transfer is supported by the DUT).
   2. Verify that a Handsfree call is established.
   3. Verify that photo is displayed (if photo transfer is supported by the DUT).
   4. Via VCS place the call on hold.
   5. Verify that the call has been placed on hold and that VCS reflects that the call is on hold.
   6. Via VCS retrieve the call from hold.
   7. Verify that the call is now Handsfree and that VCS reflects that the call is no longer on hold.
   8. End the call via DUT.
Expected Result 1. A Handsfree call shall be established.
   2. The photo of the contact shall be displayed via VCS (if photo transfer is supported by the DUT)
   3. VCS shall place the call on hold and indicate to the user that the call is on hold.
   4. VCS shall retrieve the call from hold and indicate to the user that the call is no longer on hold.
   5. The DUT shall end the call and VCS shall indicate that the call was ended and no longer display any active calls.

Placing a Call on Hold Via the DUT
Device Profiles DUT supports HFP
TBD Validate that VCS will reflect that an active call has placed on hold when initiated from the DUT.
Pre-Test Condition 1. DUT and VCS have been paired and is connected.
Procedure 1. Via the DUT, place an outgoing call.
   2. Verify that a Handsfree call is established.
   3. Via the DUT place the call on hold.
   4. Verify that the call has been placed on hold and that VCS reflects that the call is on hold.
   5. Via the DUT retrieve the call from hold.
   6. Verify that the call is now Handsfree and that VCS reflects that the call is no longer on hold.
   7. End the call via DUT.
Expected Result 1. A Handsfree call shall be established.
   2. VCS shall to the user that the call is on hold.
   3. VCS shall indicate to the user that the call is no longer on hold.
   4. The DUT shall end the call and VCS shall indicate that the call was ended and no longer display any active calls.

Establishing a Second Outgoing Call
Device Profiles DUT supports HFP
TBD Validate that VCS can establish a second outgoing Handsfree call.
Pre-Test Condition 1. DUT and VCS have been paired and is connected.
   2. Phonebook with photos has been downloaded and available within VCS.
   3. Display photos should be set to ‘ON’
Procedure 1. Via VCS, select a phonebook contact with a photo (if photo transfer is supported by the DUT).
   2. Verify that a Handsfree call is established.
   3. Verify that photo is displayed (if photo transfer is supported by the DUT).
   4. Via VCS establish another outgoing call by using the dial pad.
   5. Verify that a second call has been established.
   6. Toggle between calls 1 and calls 2 by pressing the Dial button via VCS.
   7. Verify that the active call indicated via VCS matches the active call each time the call is toggled via the Dial button. (If photo transfer is supported via the DUT, confirm that the photo is updated each time the call is toggled.)
   8. End one of the calls via VCS by pressing the End button.
   9. Verify that the remaining call becomes the active call.
Expected Result 1. A Handsfree call shall be established.
   2. The photo of the contact shall be displayed via VCS (if photo transfer is supported by the DUT)
   3. A second Handsfree call shall be established.
   4. VCS shall toggle between both calls and display the correct active call as well as photo (if photo transfer is supported by the DUT).
   5. VCS shall end one of the active calls, and the remaining call shall become the active.

Joining Calls Via VCS from an Incoming Call Waiting
Device Profiles DUT supports HFP
TBD Validate that VCS can join two calls from a call waiting scenario.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS.
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Answer the call waiting call, via VCS.
   7. Toggle between calls 1 and calls 2 by pressing the Dial button via VCS.
   8. Verify that active call indicated via VCS matches the active call each time the call is toggled via the Dial button.
   9. Via VCS, join the two calls.
   10. Verify that the calls have been joined, and that VCS indicates that the calls have been joined.
   11. End the calls via VCS.
   12. Repeat procedure Q additional times. In one illustrative embodiment, Q=2.
Expected Result 1. A Handsfree call shall be established.
   2. An incoming call waiting notification shall be displayed. The photo of the contact shall be displayed via VCS (if photo transfer is supported by the DUT)
   3. VCS shall answer the incoming call waiting call.
   4. VCS shall toggle between both calls and display the correct active call as well as photo (if photo transfer is supported by the DUT).
   5. VCS shall join the calls and indicate that the calls have been joined.
   6. VCS shall end both calls, and no longer indicate that there are any active calls.

Joining Calls Via VCS from a Second Outgoing Call
Device Profiles DUT supports HFP
TBD Validate that VCS can join two calls when one of the calls was established as a second outgoing call.
Pre-Test Condition 1. DUT and VCS have been paired and is connected.
   2. Phonebook with photos has been downloaded and available within VCS.
   3. Display photos should be set to ‘ON’
Procedure 1. Via VCS, select a phonebook contact with a photo (if photo transfer is supported by the DUT).
   2. Verify that a Handsfree call is established.
   3. Verify that photo is displayed (if photo transfer is supported by the DUT).
   4. Via VCS establish another outgoing call by using the dial pad.
   5. Verify that a second call has been established.
   6. Toggle between calls 1 and calls 2 by pressing the Dial button via VCS.
   7. Verify that the active call indicated via VCS matches the active call each time the call is toggled via the Dial button. (If photo transfer is supported via the DUT, confirm that the photo is updated each time the call is toggled.)
   8. Via VCS, join the two calls.
   9. Verify that the calls have been joined, and that VCS indicates that the calls have been joined.
   10. End the calls via VCS
   11. Repeat procedure Q additional times.
Expected Result 1. A Handsfree call shall be established.
   2. The photo of the contact shall be displayed via VCS (if photo transfer is supported by the DUT)
   3. A second Handsfree call shall be established.
   4. VCS shall toggle between both calls and display the correct active call as well as photo (if photo transfer is supported by the DUT).
   5. VCS shall join the calls and indicate that the calls have been joined.
   6. VCS shall end both calls, and no longer indicate that there are any active calls.

Multiple Call Tracking
Device Profiles DUT supports HFP
TBD Validate that VCS can keep track of the number of active calls on the DUT when a held call has disconnected from the far end.
Pre-Test Condition 1. DUT and VCS have been paired and is connected.
   2. Phonebook with photos has been downloaded and available within VCS.
   3. Display photos should be set to ‘ON’
Procedure 1. Place a call to the DUT
   2. Answer the call via VCS
   3. Verify that a Handsfree call is established.
   4. Place another call to the DUT from a contact with a photo associated within VCS's phonebook (if photo transfer is supported by the DUT).
   5. Verify that VCS notifies the user that there is an incoming call waiting call, and that the photo is displayed (if photo transfer supported by the DUT).
   6. Answer the call waiting call, via VCS.
   7. Toggle between calls 1 and calls 2 using the DUT
   8. Verify that active call indicated via VCS matches the active call each time the call is toggled via the DUT.
   9. End the held call from the far end.
   10. Verify that the VCS notifies the user that the held call has ended, and that there is only one active call present.
Expected Result 1. A Handsfree call shall be established.
   2. An incoming call waiting notification shall be displayed. The photo of the contact shall be displayed via VCS (if photo transfer is supported by the DUT)
   3. VCS shall answer the incoming call waiting call.
   4. VCS shall display the correct active call as well as photo (if photo transfer is supported by the DUT).
   5. VCS shall indicate that the held call is no longer present and that there is only one active call.

Ending Call Via VCS
Device Profiles DUT supports HFP
TBD Validate that VCS can end a Handsfree call.
Pre-Test Condition 1. DUT and VCS have been paired and is connected.
Procedure 1. Place an outgoing call via the DUT.
   2. Verify that a Handsfree call is established.
   3. End the call via VCS.
Expected Result 1. A Handsfree call shall be established.
   2. VCS shall end the call on the DUT and shall not display any active calls.

Ending Call Via DUT
Device Profiles DUT supports HFP
TBD Validate that VCS can indicate that a Handsfree call has ended.
Pre-Test Condition 1. DUT and VCS have been paired and is connected.
Procedure 1. Place an outgoing call via the DUT.
   2. Verify that a Handsfree call is established.
   3. End the call via DUT.
Expected Result 1. A Handsfree call shall be established.
   2. The DUT shall end the call and VCS shall indicate that the call was ended and no longer display any active calls.

Ending Call Via Far End
Device Profiles DUT supports HFP
TBD Validate that VCS indicates that an active call has ended.
Pre-Test Condition 1. DUT and VCS have been paired and is connected.
Procedure 1. Place an outgoing call via the DUT.
   2. Verify that a Handsfree call is established.
   3. End the call via the Far End.
Expected Result 1. A Handsfree call shall be established.
   2. The DUT shall end the call and VCS shall indicate that the call was ended and no longer display any active calls.

Incoming Text Message Alert (Single)
Device Profiles DUT supports HFP
TBD Validate that VCS is able to alert the user a newly received message on the DUT.
Pre-Test Condition 1. DUT and VCS have been paired and is connected.
Procedure 1. Send a new text message to the DUT.
   2. Verify that VCS notifies user of the unread text message.
   3. Verify that the contents of the text message match displayed within VCS matches the contents of the message of the DUT.
Expected Result 1. VCS notifies user of newly received text message.
   2. Text messages displayed within VCS match the contents of the text message within the DUT. (Phone # and message)

Unread Text Messaging Alert Upon Connection
Device Profiles DUT supports HFP
TBD Validate that VCS is able to alert the user of new messages on the DUT upon a connection.
Pre-Test Condition 1. DUT has passed the “Incoming Text Message Alert Single Test”
   2. DUT and VCS have been paired.
   3. DUT shall be set to ‘Favorite’ phone.
   4. Auto-Phonebook Download is set to ON.
   5. Phonebook within VCS has been deleted.
   6. DUT has at least 100 phonebook contacts stored within its' memory.
   7. DUT has at least 7 unread text messages.
   8. VCS is suspended.
Procedure 1. Resume VCS.
   2. Verify that VCS notifies user of the unread text messages.
   3. Verify that the contents of the text messages match displayed within VCS matches the contents of the messages of the DUT.
   4. Within the phonebook tab, verify that the phonebook has been downloaded.
Expected Result 1. VCS notifies user of newly received text messages.
   2. Text messages displayed within VCS match the contents of the text messages within the DUT. (Phone # and message)
   3. Phonebook contacts from the DUT are present within VCS
   4. Connection is maintained.

Incoming Text Message Alert (Multiple)
Device Profiles DUT supports HFP
TBD Validate that VCS is able to alert the user a newly received messages on the DUT.
Pre-Test Condition 1. DUT and VCS have been paired and is connected.
   2. DUT has passed the “Incoming Text Message Alert Single Test”
Procedure 1. Send 5 new text messages to the DUT.
   2. Verify that VCS notifies user of the unread text messages.
   3. Verify that the contents of the text messages match displayed within VCS matches the contents of the messages of the DUT.
Expected Result 1. VCS notifies user of newly received text messages.
   2. Text messages displayed within VCS match the contents of the text messages within the DUT. (Phone # and message)
Device Profiles DUT supports HFP
TBD Validate that VCS is able to reply to a text message.
Pre-Test Condition 1. DUT has passed the “Incoming Text Message Alert Single Test”
   2. DUT and VCS have been paired and is connected.
   3. Messages are present within VCS from the DUT.
Procedure 1. Choose a received message within VCS to send a reply.
   2. Choose a canned response to use as the reply, and send that message.
   3. Confirm that the message sent via VCS was delivered and the contents of the message match the chosen reply.
Expected Result 1. The message chosen via VCS shall be delivered to the intended device, and the contents of the message shall match the canned reply chosen.

Sending a Text Message
Device Profiles DUT supports HFP
TBD Validate that VCS is able to send a text message.
Pre-Test Condition 1. DUT has passed the “Incoming Text Message Alert Single Test”
   2. DUT and VCS have been paired and is connected.
Procedure 1. Via VCS, select a contact within the phonebook to send a text message to
   2. Choose a canned message, and send that message.
   3. Confirm that the message sent via VCS was delivered and the contents of the message match the chosen canned message.
Expected Result 1. The message chosen via VCS shall be delivered to the intended device, and the contents of the message shall match the canned message chosen.

Audio Streaming (Play/Pause)
Device Profiles DUT supports HFP and A2DP and AVRCP 1.0 or greater
TBD Validate that VCS can play/pause the media of the DUT.
Pre-Test Condition 1. DUT and VCS have been paired and is connected.
   2. Media is present on the device
Procedure 1. Select the DUT within VCS's entertainment menu.
   2. If music does not begin playing, launch the media player within the DUT to begin playing.
   3. Via VCS press the Pause button to pause the music.
   4. Verify that the music has been paused.
   5. Via VCS press the Play button to resume playing the music
   6. Verify that the music resumes playing.
Expected Result 1. Media begins playing after selecting device within VCS's entertainment menu.
   2. Media is paused after selection is made via VCS.
   3. Media resumes after play is selected via VCS.

Audio Streaming (Next Track/Previous Track)
Device Profiles DUT supports HFP and A2DP and AVRCP 1.0 or greater
TBD Validate that VCS can advance to the next or previous tracks of the DUT.
Pre-Test Condition 1. DUT and VCS have been paired and is connected.
   2. Media is streaming from the DUT to VCS.
Procedure 1. Via VCS, press Next Track.
   2. Verify that the media advances to the next track.
   3. Via VCS, press Previous Track
   4. Verify that the media advances to the previous track.
Expected Result 1. Media advances to the next track when selection is made via VCS.
   2. Media advances to the previous track when selection is made via VCS.

Audio Streaming (Fast Forward/Rewind Track)
Device Profiles DUT supports HFP and A2DP and AVRCP 1.0 or greater
TBD Validate that VCS can advance to the next or previous tracks of the DUT.
Pre-Test Condition 3. DUT and VCS have been paired and is connected.
   4. Media is streaming from the DUT to VCS.
Procedure 5. Via VCS, press and hold the Next Track button for approx. 10 seconds.
   6. Verify that the media advances within the current track and the current track resumes playing.
   7. Via VCS, press and hold the Previous Track for approx. 10 seconds
   8. Verify that the media rewinds within the current track and the current track resumes playing.
   9. Press Pause.
   10. Verify that the track has paused.
   11. Press Play.
   12. Verify that the track resumes playing
   13. Press next track.
   14. Verify that the track has advanced to the next track.
   15. Press previous track.
   16. Verify that the track changed to the beginning of the existing track OR the previous track.
Expected Result 3. The media fast forwards and rewinds when commanded via VCS.
   4. After the fast forward/rewind commands VCS still has the ability to command and control the source (i.e. Play, Pause, Next Track, Previous Track).

Audio Streaming (Metadata of Current Playing Track)
Device Profiles DUT supports HFP and A2DP and AVRCP 1.3 or greater
TBD Validate that VCS can display the meta data of the media of the DUT.
Pre-Test Condition 1. DUT and VCS have been paired and is connected.
   2. Media is present on the DUT
Procedure 1. Select the DUT within VCS's entertainment menu.
   2. If music does not begin playing, launch the media player within the DUT to begin playing.
   3. Verify that the meta data of the currently playing track is displayed via VCS
   4. Via VCS, press Next Track.
   5. Verify that the media advances to the next track.
   6. Verify that the meta data of the currently playing track is displayed via VCS
   7. Via VCS, press Previous Track
   8. Verify that the media advances to the previous track.
   9. Verify that the meta data of the currently playing track is displayed via VCS
   10. Via the DUT, press Next Track.
   11. Verify that the media advances to the next track.
   12. Verify that the meta data of the currently playing track is displayed via VCS
   13. Via the DUT, press Previous Track
   14. Verify that the media advances to the previous track.
   15. Verify that the meta data of the currently playing track is displayed via VCS
Expected Result 1. Meta data is displayed for each track that is played.
   Audio Streaming (Browsing)
Device Profiles DUT supports HFP and A2DP and AVRCP 1.4
TBD Validate that VCS can index the meta data of the DUT. Validate that VCS can direct the DUT to play a specific track, artist, and/or album.
Pre-Test Condition 1. DUT and VCS have been paired and is connected.
   2. Media is present on the DUT (at least 50 tracks, 10 albums, and 10 artists)
Procedure 1. Select the DUT within VCS's entertainment menu.
   2. If music does not begin playing, launch the media player within the DUT to begin playing.
   3. Via VCS confirm that the meta data index has been downloaded by checking on track per album.
   4. Via VCS, choose a track to play.
   5. Verify that the selected track is played and that the meta data of the currently playing track is displayed via VCS
   6. Via VCS, choose an album to play
   7. Verify that the selected album is played and that the meta data of the currently playing track is displayed via VCS
   8. Via VCS, choose an artist to play
   9. Verify that the selected artist is played and that the meta data of the currently playing track is displayed via VCS
   10. Via VCS, press Next Track
   11. Verify that the media advances to the next track.
   12. Verify that the meta data of the currently playing track is displayed via VCS
   13. Via VCS, press Previous Track
   14. Verify that the media advances to the previous track.
   15. Verify that the meta data of the currently playing track is displayed via VCS
   16. Via the DUT, press Next Track.
   17. Verify that the media advances to the next track.
   18. Verify that the meta data of the currently playing track is displayed via VCS
   19. Via the DUT, press Previous Track
   20. Verify that the media advances to the previous track.
   21. Verify that the meta data of the currently playing track is displayed via VCS
Expected Result 1. Meta data index of the device is displayed within VCS.
   2. User is able to select a specific track, album, and artist via VCS, and that selection shall be played.
   3. Meta data is displayed for each track that is played.

Audio Streaming and Calls
Device Profiles DUT supports HFP and A2DP and AVRCP 1.0 or greater
TBD Validate that VCS is able to make and receive calls while streaming audio. Validate that audio resumes after calls have ended.
Pre-Test Condition 1. DUT and VCS have been paired and is connected.
   2. Media is streaming from the DUT to VCS.
Procedure 1. Via VCS, initiate an outgoing call using the dial pad.
   2. Verify that the call was established.
   3. End the call via VCS
   4. Verify that the media resumes streaming after the call has ended.
   5. Place a call to the DUT
   6. Answer the incoming call via VCS.
   7. End the call via the far side
   8. Verify that the media resumes streaming after the call has ended.
Expected Result 1. An outgoing call shall be established while streaming.
   2. Streaming shall be resumed once the call has ended.
   3. An incoming call can be accepted while streaming.
   4. Streaming shall be resumed once the call has ended.

Personal Area Networking Connection
Device Profiles DUT supports HFP and Personal Area Networking
TBD Validate that VCS can access the internet via a Personal Area Network connection
Pre-Test Condition 1. DUT and VCS have been paired and connected
   2. A laptop is connected to VCS via Wi-Fi
Procedure 1. Via VCS, initiate a PAN connection to the DUT.
   2. Verify that PAN is connected (via Phone HMI)
   3. Using the computer, confirm that it can access the internet via the Wi-Fi connection between it and VCS
Expected Result 1. A PAN connection to be established between the DUT and VCS.
   2. The computer can access the internet via the Wi-Fi connection between it and VCS.

Personal Area Networking Connection and Calls
Device Profiles DUT supports HFP and Personal Area Networking
TBD Validate that VCS can access the internet via a Personal Area Network connection
Pre-Test Condition 1. DUT and VCS have been paired and connected
   2. A PAN connection is established between VCS and the DUT
   3. A laptop is connected to VCS via Wi-Fi
Procedure 1. Place an outgoing call via VCS.
   2. Verify that the call has been established
   3. Verify that the PC still has an internet connection via Wi-Fi
   4. End the call via VCS
   5. Verify that the PC still has an internet connection via Wi-Fi
   6. Place an incoming call to the DUT
   7. Answer the incoming call via VCS
   8. Verify that the call has been established.
   9. Verify that the PC still has an internet connection via Wi-Fi
   10. End the call via VCS
   11. Verify that the PC still has an internet connection via Wi-Fi
Expected Result 1. An outgoing or incoming call can be established.
   2. The computer can access the internet via the Wi-Fi connection between it and VCS during and after an incoming/outgoing call.

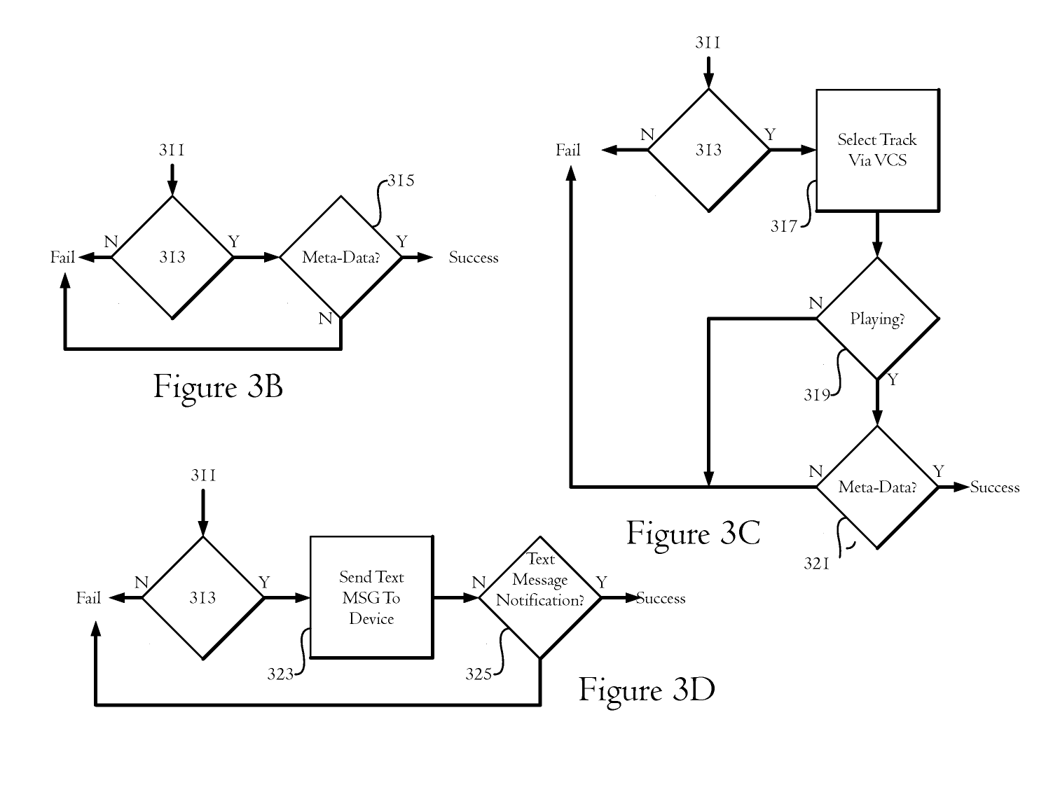

FIG. 3A shows an illustrative example of a process for testing audio playback capability when music is being streamed from a mobile device to a VCS. In this illustrative process, the device has already been connected to the VCS 205, and audio is streamed from the device to the VCS 301. The operation of the VCS is then suspended 303, and it is determined if the mobile device disconnects upon suspension 305. If the device fails to disconnect, the test fails.

If the device successfully disconnects, operation of the VCS is resumed 307 and it is determined if audio playback also resumes 309. Resumption of audio play indicates a successful test, but if audio play does not resume, then play is pressed on the device 311 and it is checked again if audio playback resumes 313. If audio playback resumes, then the test is a success, if audio playback doesn't resume, then the test is a failure.

FIG. 3B shows a second example of testing audio playback capability with a meta-data component. In this illustrative example, meta-data is also sent from the wireless device to the VCS. This could include, but is not limited to, track number, song name, artist name, etc. Once playback is resumed 313, it is also determined if the meta data resumes processing 315. If the meta-data is displayed, the test is a success.

FIG. 3C shows an example of testing audio playback control from a VCS. In this illustrative example, once playback has resumed 313, a new track is selected for play via the VCS 317. If the track successfully plays 319, it is also determined if any meta data associated with the track is displayed 321. If either the track does not play, or the metadata is not displayed, the test fails, otherwise it is a success.

FIG. 3D shows an example of testing control over an incoming text message while audio playback is processing. In this illustrative example, a text message is sent to the device that is streaming audio to the VCS 323. Since the VSC has text display or notification capability, the process checks to see if the text message is displayed or if a text notification is presented 325. If the text display/notification does not occur, the test is a failure, otherwise the test is a success.

FIG. 3E shows an example of testing control over an incoming call while audio playback is processing. In this illustrative example, the test includes placing a call to the device 329 sending audio to the VCS. Then, it is determined whether or not the call was received at the VCS 331. If the VCS does not notify the user of an incoming call, the process fails.

If the user is notified of the incoming call, it is determined whether audio playback is stopped and hands-free calling is available 333. If hands-free calling is available 333, the process was a success.

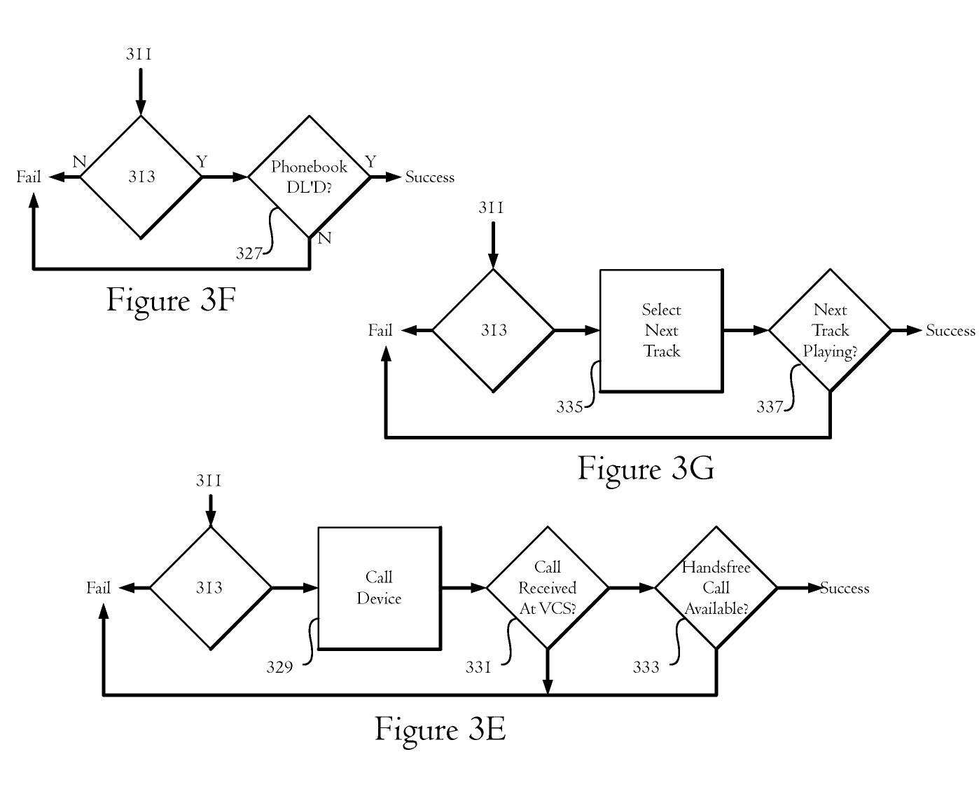

FIG. 4 shows an example of a process for testing contact import from a device to the VCS. In this illustrative process, a search is made for a hands-free device 401 from the VCS. If the device is found 403, a connection is established between the VCS and the device 405.

Once a connection has been established, contacts are downloaded from the device to the VCS 407. Contacts can include, but are not limited to, name, number, email address, picture, physical address, etc. Any information that may be stored with respect to a contact in the device may also be downloaded to the VCS for use by the VCS.

The downloaded contacts are then accessed via the VCS 409 to ensure that the contacts exist on the VCS 411. If the download was unsuccessful, the process fails, otherwise the device is then disconnected from the VCS 413. Once the device is disconnected from the VCS, a contact is added to the list of contacts stored on the device 415. Additionally (or alternatively) a contact is deleted from the device as well 417. Once a contact has been added and/or deleted, the device is reconnected to the VCS 419. The contacts are then updated between the device and the VCS and it is determined if the new contact is now present on the VCS 421. It is also determined is the contact that was deleted is now gone from the VCS 423. If the new contact is present and the deleted contact is no longer present in the VCS contacts, the test was a success. If either check fails then the test was a failure.

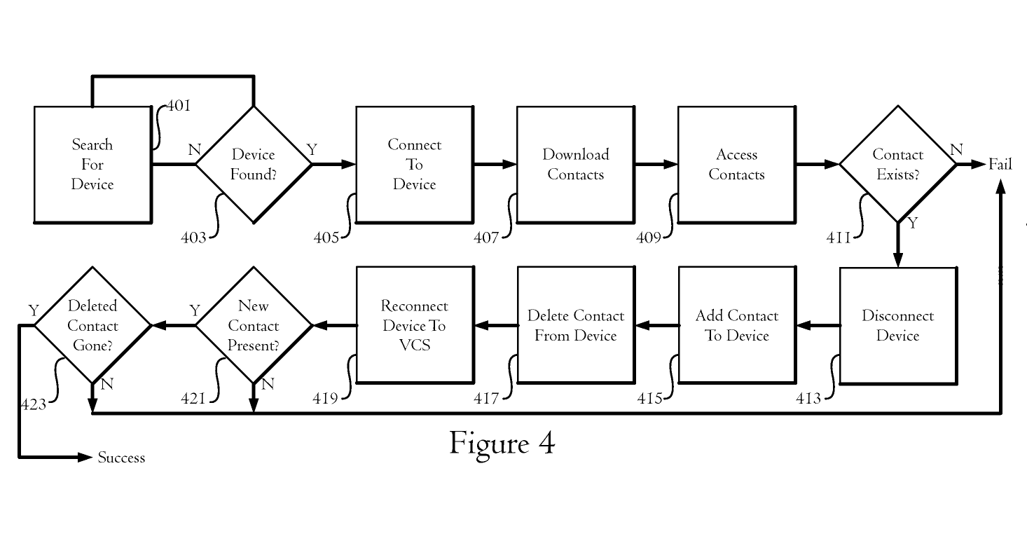

FIG. 5 shows an example of testing a caller ID feature of the VCS. In this illustrative example, as with in FIG. 4, some or all of an address book is downloaded from a connected wireless device to the VCS 501. After the download is complete, a call is placed to the device 503. When the call is connected to the device, it is determined if a ring or other notification is made via the VCS 505. If the VCS notifies the user, it is also determined if a contact corresponding to the caller is displayed (or output audibly) via the VCS 507. If the VCS doesn't notify the user of the call, or if the contact is not output by the VCS, the test fails.

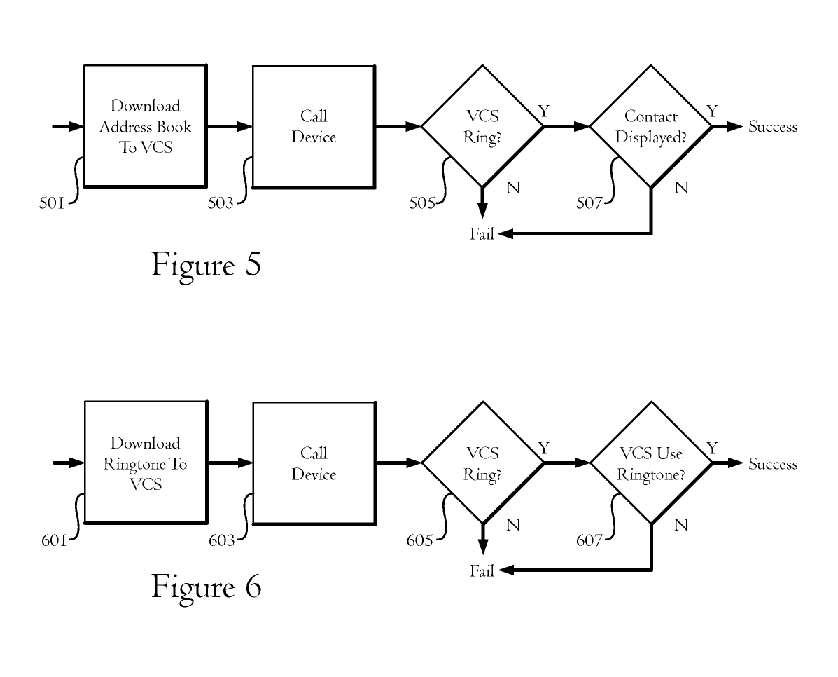

FIG. 6 shows an example of testing a ringtone feature of the VCS. In this illustrative embodiment, the VCS is capable of reproducing a ringtone associated with a device or a specific contact. Along with contact information (if needed), one or more ringtones is also downloaded to the VCS 601.

A call is then placed to the remote device 603, and it is determined if a ring plays in the VCS when the call is connected 605. If a ring plays, it is also determined if the played ring corresponds to the downloaded ringtone appropriate for that caller.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
pairing a BLUETOOTH device and a vehicle computing system (VCS);
setting the device to a preferred device;
streaming audio from the device to the VCS, such that the audio is played by the VCS;
suspending the VCS;
verifying that the VCS and the device are disconnected;
resuming the suspended VCS;
if the audio does not resume play, instructing the audio to play from the VCS;
instructing the audio to move to a next track, using the VCS in conjunction with an audio video remote control profile (AVRCP); and
validating the operability between the device and the VCS contingent at least on the discontinuation of audio playback when the VCS is suspended and the establishment of an audio connection resulting in audio playback upon resumption of the suspended VCS.

2. The method of claim 1, wherein the device has at least a predefined number of media tracks stored thereon, wherein the method further comprises verifying that meta-data of a current playing track is displayed on a vehicle display, and wherein the validating further includes validating the operability contingent on at least the verification that meta-data of a current playing track is displayed on the vehicle display.

3. The method of claim 2, wherein the device additionally has a predefined number of albums and artists stored thereon, wherein the method further comprises:
selecting a track for play using a menu function provided by the VCS; and
verifying that the selected track begins playback upon request and that the appropriate meta-data is displayed on the vehicle display.

4. The method of claim 1, further comprising:
sending a text message to the device;
verifying that the VCS notifies a user of the text message, wherein the validating further includes validating the operability contingent on the notification of the text message.

5. The method of claim 1, further comprising:
setting the VCS to download a phone book from the device, wherein the device has a predetermined number of phonebook entries stored therein;
verifying that the phonebook has been downloaded from the device by the VCS, wherein the validating further includes validating the operability contingent on the download of the phonebook by the VCS.

6. The method of claim 1, further comprising:
establishing an active phone call on the device, while the VCS is suspended; and
verifying that the VCS establishes connection to the device and provides a hands-free call functionality for the active phone call, wherein the validating further includes validating the operability contingent on the VCS providing hands-free functionality for the active phone call.

7. The method of claim 1, further comprising:
selecting a pause option provided by the VCS;
verifying that the audio is paused;
selecting a resume option provided by the VCS; and
verifying that the audio resumes playback, wherein the validating further comprises validating operability contingent on pause and resumption of audio playback corresponding to selection of pause and resume functions provided by the VCS.

8. The method of claim 1, further comprising:
selecting a next track option provided by the VCS; and
verifying that the audio moves to a next track, wherein the validating further comprises validating operability contingent on playback of a next track upon selection of a next track option provided by the VCS.

9. A method comprising:
searching for a paired wireless device via a vehicle computing system (VCS), wherein the wireless device has at least a minimum number of contacts stored thereon;
downloading the contacts via the VCS;
verifying that the contacts have been downloaded by accessing one or more contacts via the VCS;
disconnecting the VCS from the device;
deleting one or more contacts from the device while the device is disconnected from the VCS;
adding one or more contacts to the device while the device is disconnected from the VCS;
reconnecting the VCS to the device;
verifying that the at least one of the deleted contacts is no longer available via the VCS;
verifying that at least one of the added contacts is available via the VCS;
validating the operability between the device and the VCS contingent on at least verifying that the contacts are downloaded to the VCS and are accessible via the VCS, that the deleted contacts are no longer available via the VCS and that the added contacts are available via the VCS.

10. The method of claim 9, wherein one or more of the contacts has an address associated therewith, further comprising:
verifying that the address associated with a contact is available via the VCS, wherein the validating is further contingent on verifying that the address associated with the contact is available via the VCS.

11. The method of claim 9, wherein one or more of the contacts has an email address associated therewith, further comprising:
verifying that the email address associated with a contact is available via the VCS, wherein the validating is further contingent on verifying that the email address associated with the contact is available via the VCS.

12. The method of claim 9, wherein one or more of the contacts has an image associated therewith, further comprising:
verifying that the image associated with a contact is available via the VCS, wherein the validating is further contingent on verifying that the image associated with the contact is available via the VCS.

13. A method comprising:
connecting a vehicle computing system (VCS) and a device, wherein the device includes an address book with at least one contact;
downloading the address book to the VCS;
calling the device, from a phone number stored in the address book of the device;
verifying that contact information associated with the phone number from which the calling was performed is displayed by the VCS; and
validating the operability between the device and the VCS contingent at least on verifying that contact information associated with the phone number from which the calling was performed is displayed on the VCS.

14. A method comprising:
connecting a vehicle computing system (VCS) and a device, wherein the device has at least one ringtone associated therewith, which plays when an incoming call arrives;
calling the device;
verifying that the VCS plays the ringtone associated with the device when the device is called; and
validating the operability between the device and the VCS contingent at least on verifying that the VCS plays the ringtone associated with the device when the device is called.

15. A method comprising:
connecting a vehicle computing system (VCS) and a device;
calling the device;
rejecting an incoming call to the device;
verifying that the VCS ceases display of the incoming call once the call has been rejected; and
validating the operability between the device and the VCS contingent at least on verifying that the VCS ceases display of the incoming call once the call has been rejected.

16. The method of claim 15, wherein the rejecting is performed via the VCS.

17. The method of claim 15, wherein the rejecting is performed via the VCS by an automatic do not disturb function running on the VCS.

18. The method of claim 15, wherein the rejecting is performed via the device.

19. A method comprising:
connecting a vehicle computing system (VCS) and a device;
calling the device;
answering an incoming call to the device;
verifying that the VCS establishes a hands-free state for handling the incoming call; and
validating the operability between the device and the VCS contingent at least on verifying that the VCS establishes a hands-free state for handling the incoming call.

20. The method of claim 19, wherein the answering is performed via the VCS.

21. The method of claim 19, wherein the answering is performed via the device.

22. A method comprising:
connecting a vehicle computing system (VCS) and a device;
placing a call through the device;
verifying that the VCS establishes a hands-free state for handling the placed call, including displaying known contact information for a call recipient if available; and
validating the operability between the device and the VCS contingent at least on verifying that the VCS establishes a hands-free state for handling the placed call, including displaying known contact information for a call recipient if available.

23. The method of claim 22, wherein the placing a call is performed via the VCS.

24. The method of claim 22, wherein the placing a call is performed via the device.
